(19) United States
(12) Patent Application Publication
(10) Pub. No.: US 2024/0155400 A1
(43) Pub. Date: May 9, 2024

(54) METHOD AND DEVICE FOR MEASURING QOE IN WIRELESS COMMUNICATION SYSTEM

(71) Applicant: Samsung Electronics Co., Ltd., Suwon-si (KR)

(72) Inventors: Seungbeom JEONG, Suwon-si (KR); Sangyeob JUNG, Suwon-si (KR)

(21) Appl. No.: 18/496,497

(22) Filed: Oct. 27, 2023

(30) Foreign Application Priority Data
Nov. 3, 2022 (KR) 10-2022-0145551

(51) Int. Cl. H04W 24/10; H04L 12/18; H04W 28/02

(52) U.S. Cl. CPC H04W 24/10; H04L 12/189; H04W 28/0268

(57) ABSTRACT

The disclosure relates to a 5G or 6G communication system for supporting a higher data transmission rate. A method performed by a user equipment (UE) in a wireless communication system is provided. The method includes receiving, from a base station, configuration information for a quality of experience (QoE) measurement, storing a result of the QoE measurement performed in a radio resource control (RRC) idle state or an RRC inactive state in an access stratum (AS) layer memory of the UE, and transmitting, to the base station, a QoE report including the result of the QoE measurement based on the configuration information.

### CROSS-REFERENCE TO RELATED APPLICATION(S)

This application is based on and claims priority under 35 U.S.C. § 119(a) of a Korean patent application number 10-2022-0145551, filed on Nov. 3, 2022, in the Korean Intellectual Property Office, the disclosure of which is incorporated by reference herein its entirety.

### BACKGROUND

### 1. Field

The disclosure relates to measuring quality of experience (QoE) in a wireless communication system. More particularly, the disclosure relates to a method and a device for measuring QoE in idle and inactive modes in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In a wireless communication system, a user equipment (UE) and a base station may transmit and/or receive signals for efficient measurement of quality of experience (QoE) measurement.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a device for efficiently transmitting and/or receiving signals in a wireless communication system.

Another aspect of the disclosure is to provide a method and a device for efficiently transmitting and/or receiving signals between a base station and a UE by measuring quality of experience (QoE) in standby and inactive modes in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, configuration information for a quality of experience (QoE) measurement, storing a result of the QoE measurement performed in a radio resource control (RRC) idle state or an RRC inactive state in an access stratum (AS) layer memory of the UE, and transmitting, to the base station, a QoE report including the result of the QoE measurement based on the configuration information.

The disclosure may provide a method and a device capable of transmitting and/or receiving signals for effective measurement of quality of experience (QoE) in a wireless communication system.

Other aspects, advantages, and salient features of the disclosure will become apparent to those skilled in the art of from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a structure of a wireless communication system according to an embodiment of the disclosure;

FIG. 1B illustrates wireless connection state transitions in a wireless communication system according to an embodiment of the disclosure;

FIG. 1C illustrates a technology for collecting and reporting cell measurement information according to an embodiment of the disclosure;

FIG. 1D illustrates a method for collecting and reporting cell measurement information according to an embodiment of the disclosure;

FIG. 1E illustrates operations of collecting and reporting cell measurement information according to an embodiment of the disclosure;

FIG. 1F illustrates an operation of configuring and/or reporting signaling-based QoE measurement according to an embodiment of the disclosure;

FIG. 1G illustrates a procedure for configuring and/or reporting management-based QoE measurement according to an embodiment of the disclosure;

FIG. 1H is a flowchart illustrating a procedure for configuring and reporting RAN visible QoE measurement according to an embodiment of the disclosure;

FIG. 1I illustrates operations performed between a base station and a UE AS for QoE measurement according to an embodiment of the disclosure;

FIG. 1Y illustrates an inner structure of a UE according to an embodiment of the disclosure; and

FIG. 1Z illustrates a configuration of a base station according to an embodiment of the disclosure.

FIG. 2 illustrates communication between a user equipment and a network.

The same reference numerals are used to represent the same elements throughout the drawing.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various embodiments of the disclosure will be described based on an approach of hardware. However, various embodiments of the disclosure include a technology that uses both hardware and software, and thus the various embodiments of the disclosure may not exclude the perspective of software.

In the following description, terms referring to device elements (e.g., control unit, processor, artificial intelligence (AI) model, encoder, decoder, autoencoder (AE), and neural network (NN) model) and terms referring to data (e.g., signal, feedback, report, reporting, information, parameter, value, bit, and codeword) are illustratively used for the sake of descriptive convenience. The disclosure is not limited by the terms as used below, and other terms having equivalent technical meanings may be used.

Various embodiments will be described using terms employed in some communication standards (e.g., the 3rd generation partnership project (3GPP)), but they are only for the sake of illustration. The embodiments of the disclosure may also be easily applied to other communication systems through modifications.

Embodiments of the disclosure will be described in detail with reference to the accompanying drawings.

In the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. The disclosure is not limited to the embodiments set forth below, but may be implemented in various different forms. The embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). It should also be noted that in some alternative implementations, the functions noted in the blocks may occur out of the order. In an example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors.

Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters.

The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

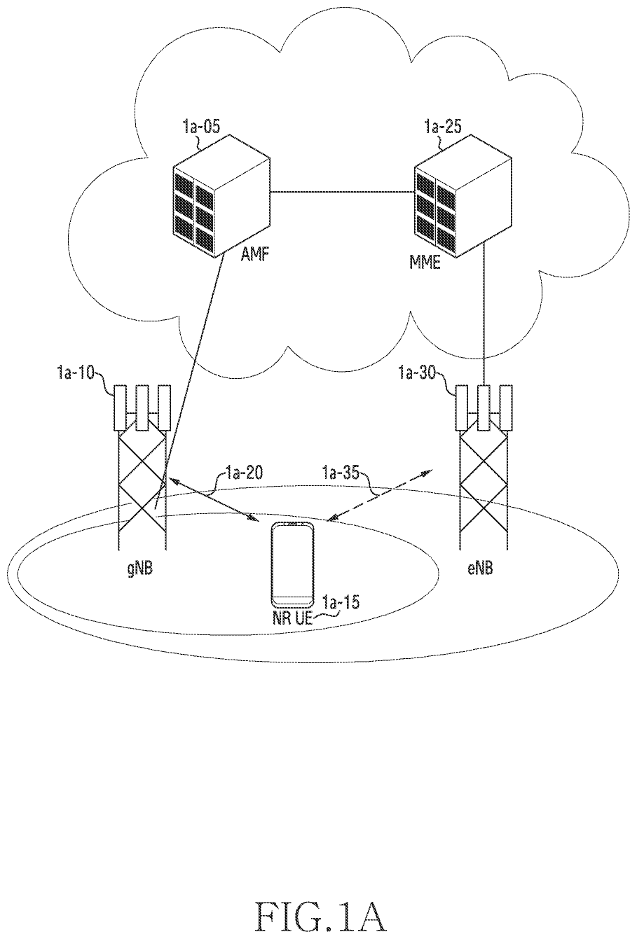

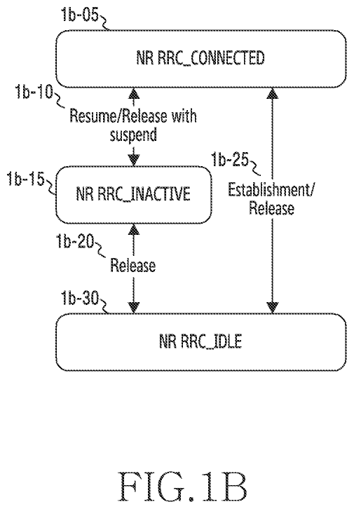

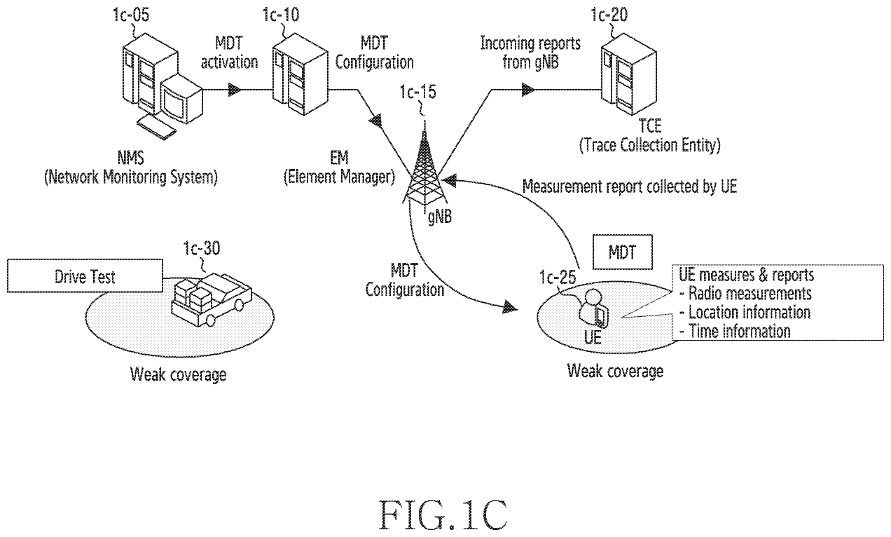

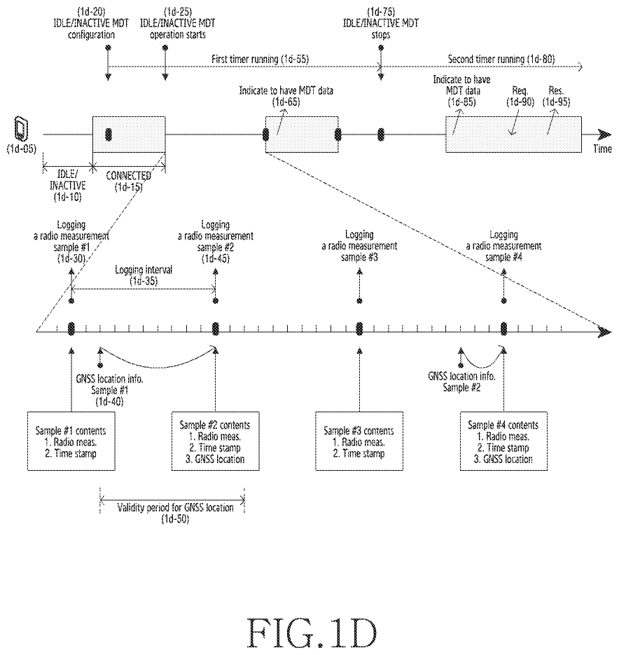

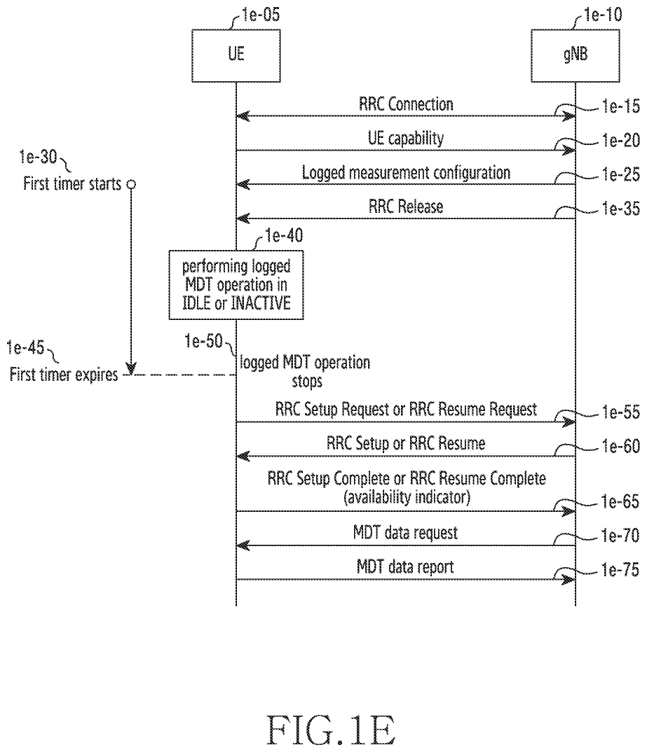

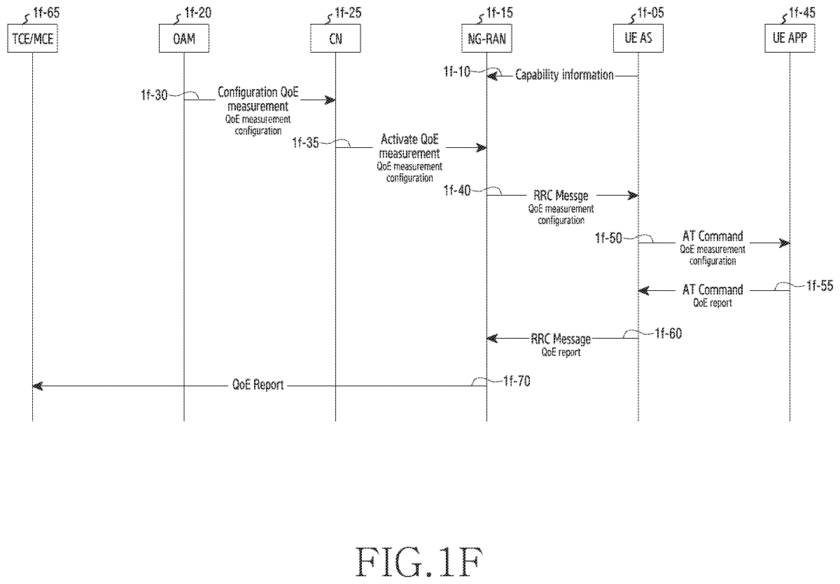

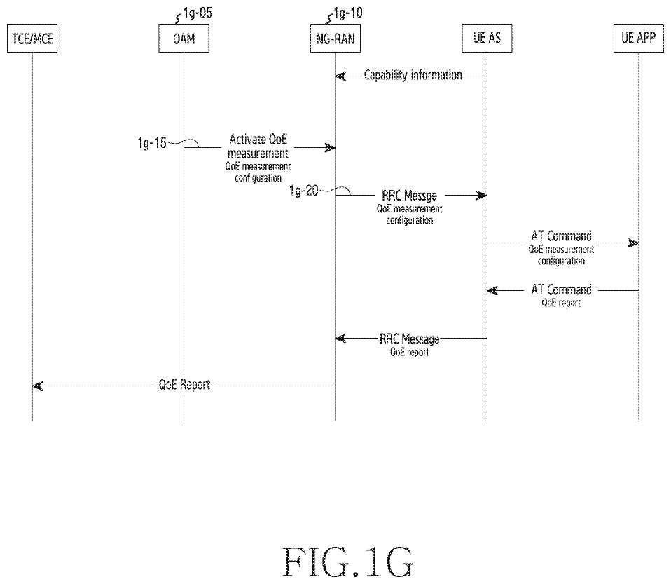

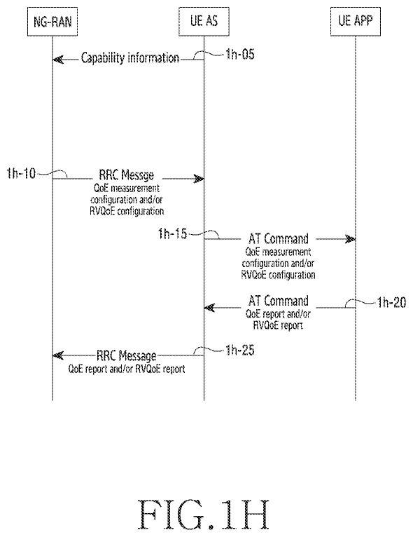

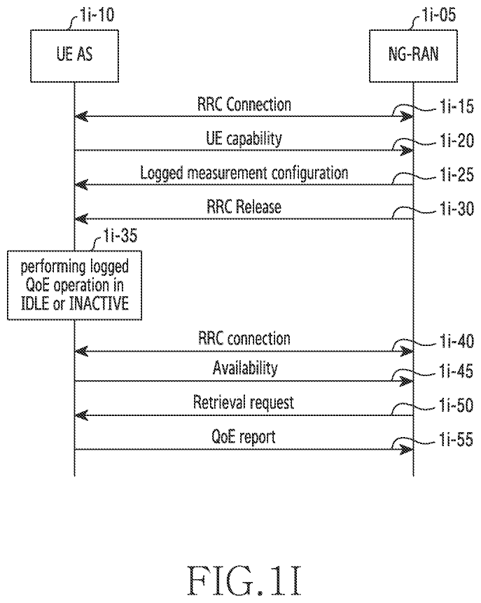

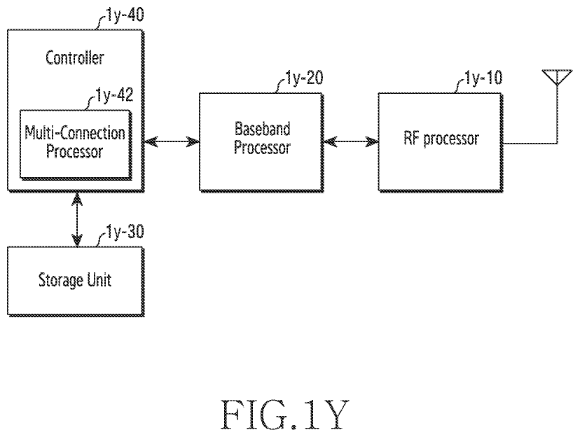

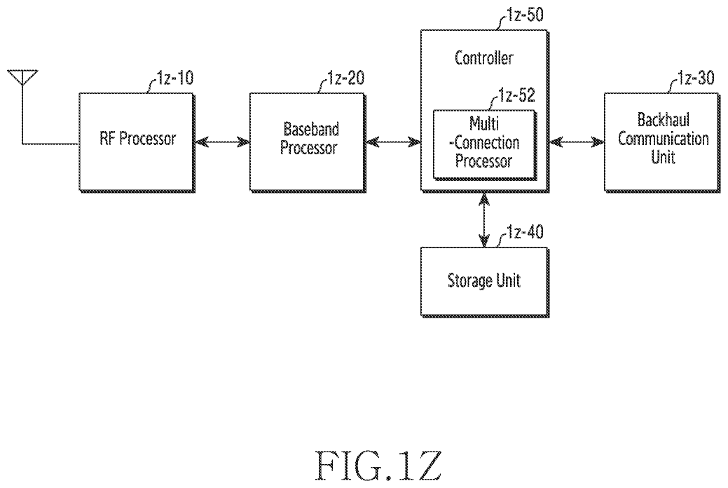

FIG. 1A illustrates a structure of a wireless communication system according to an embodiment of the disclosure.

Referring to FIG. 1A, as illustrated, a radio access network of a wireless communication system (new radio (NR)) may include a next-generation base station (new radio node B, hereinafter referred to as “gNB”) 1a-10 and an access and mobility management function (AMF) (1a-05). A new radio user equipment (hereinafter, referred to as “NR UE” or “UE”) (1a-15) may access an external network through the gNB 1a-10 and the AMF 1a-05.

In FIG. 1A, the gNB may correspond to an evolved node B (eNB) in an existing long term evolution (LTE) system. In an embodiment, the gNB may be connected to the NR UE by a wireless channel, and may provide better services than the existing node B (e.g., eNB) (1a-20). In a wireless communication system, all user traffic may be served through a shared channel, and thus a device that aggregates and schedules state information such as buffer state of UEs, an available transmission power state, a channel state, etc. may be required, and the gNB 1a-10 may serve as such a device. One gNB may typically control multiple cells. In order to realize ultra-high-speed data transfer compared to the existing LTE, the gNB may have a bandwidth equal to or more than the existing maximum bandwidth, and may use orthogonal frequency division multiplexing (OFDM) as a wireless access technology and additionally perform a beamforming technology. Additionally, an adaptive modulation & coding (AMC) may be applied to determine a modulation scheme and a channel coding rate according to the channel state of a UE. In an embodiment, the AMF (1a-05) may perform functions such as mobility support, bearer configuration, and QoS configuration.

The AMF is a device responsible for a mobility management function for the UE as well as various control functions, and may be connected to multiple base stations. In an embodiment, the wireless communication system may also interoperate with the existing LTE system, and the AMF may be connected to a mobility management entity (MME) 1a-25 via a network interface. The MME may be connected to an eNB 1a-30 which is an existing base station. A UE supporting LTE-NR dual connectivity may transmit and/or receive data while maintaining a connection to the eNB as well as the gNB (1a-35).

FIG. 1B illustrates wireless connection state transitions in a wireless communication system according to embodiments of the disclosure.

Referring to FIG. 1B, a wireless communication system may have three wireless connection states (radio remote control (RRC) states). A connected mode (RRC_CONNECTED) 1b-05 may be a wireless connection state in which a UE may transmit and/or receive data. In an embodiment, a standby mode (RRC_IDLE) 1b-30 may be a wireless connection state in which the UE monitors whether paging is being sent to the UE. Both modes are wireless connection states that are also applied to the existing LTE system, and the detailed description thereof may be identical to that of the existing LTE system. In the wireless communication system, a new inactive (RRC_INACTIVE) wireless connection state 1b-15 may be defined. In the wireless connection state, a UE context may be maintained at a base station and a UE, and radio access network (RAN)-based paging may be supported. Features of the new wireless connection state may be listed as follows:
Cell re-selection mobility;
CN-NR RAN connection (both C/U-planes) has been established for UE;
UE AS context is stored in at least one gNB and the UE;
Paging is initiated by NR RAN;
RAN-based notification area is managed by NR RAN; and
NR RAN knows the RAN-based notification area which the UE belongs to.

The new INACTIVE mode may transition to a connected or idle mode by using a specific procedure. For example, the transition from the inactive mode to the connected mode may be made by a resume process, and the transition from the connected mode to the inactive mode may be made using a release procedure with suspend configuration information (1b-10). In the above-described procedure, one or more RRC messages may be transmitted and/or received between the UE and the base station, and the above-described procedure may include one or more steps. In addition, after resuming, the transition from the inactive mode to the idle mode may be made through the release procedure (1b-20). The transition between the connected and idle modes may follow the existing LTE technology. The transition between modes may occur through an establishment or release procedure (1b-25).

FIG. 1C illustrates a technology for collecting and reporting cell measurement information according to an embodiment of the disclosure.

Referring to FIG. 1C, when constructing or optimizing a network, a mobile communication service provider may measure signal strength in an expected service area, and may deploy or readjust base stations in the expected service area, based on the measured signal strength. The provider may load a vehicle 1C-30 with signal measurement equipment so as to collect cell measurement information in the expected service area. In an embodiment, when the provider collects cell measurement information with the vehicle 1c-30, a significant amount of time and cost may be required. The process described above generally uses the vehicle 1c-30, and may thus be referred to as a drive test.

A UE 1c-25 may be equipped with a function to measure and report signals received from a base station 1c-15 in order to support operations such as cell reselection, handover, or addition of a serving cell when moving between cells. Instead of a drive test, the UE 1c-25 within the service area may be used. The use of the UE 1c-25 instead of the drive test may be referred to as minimization of drive test (MDT). In an embodiment, the provider may configure MDT operations for specific UEs through various constituent devices (e.g., including at least one of the following: network monitoring system (NMS) (1c-05), element manager (EM) (1c-10), and trace collection entity (TCE) (1c-20)). in a network. The UE 1c-25 may, for example, collect and store signal strength information from a serving cell and neighboring cells in a connected mode (RRC_Connected), an idle mode (RRC_Idle), or an inactive mode (RRC_Inactive). The UE 1c-25 may store not only the signal strength information, but also various other types of information such as location information, time information, and signal quality information. The stored information may be reported to the network when the UE 1c-25 is in the connected mode, and the reported information may be transmitted to a specific server.

Referring to Table 1 below, MDT operations may be broadly categorized into immediate MDT and logged MDT.

Immediate MDT may imply that the UE 1c-25 immediately reports the collected information to the network. Because of the need to report without delay, only the UE 1c-25 in the connected mode may perform the immediate MDT. A radio resource management (RRM) measurement process for supporting operations such as handover and serving cell addition may be reused, and location information, time information, etc. may be additionally reported.

Logged MDT may imply that the UE 1c-25 stores collected information without immediately reporting the collected information to the network, and then reports the stored information after transitioning to the connected mode. The UE 1c-25 in a standby mode that cannot report information to the network immediately may perform logged MDT. In an embodiment, the UE 1c-25 in an inactive mode introduced by a wireless communication system may perform the logged MDT. The network may, for example, provide the UE 1c-25 with configuration information for performing the logged MDT operation when a particular UE 1c-25 is in the connected mode, and the UE 1c-25 may transition to the idle or inactive mode, and then collect and store information according to the configuration information for performing the logged MDT operation.

TABLE 1

| | RRC state |
|---|---|
| Immediate MDT | RRC_Connected |
| Logged MDT | RRC_Idle, RRC_Inactive |

FIG. 1D illustrates a method for collecting and reporting cell measurement information according to an embodiment of the disclosure.

Referring to FIG. 1D, a UE 1d-05 may transition from an idle mode (not shown) or an inactive mode 1d-10 to a connected mode 1d-15. In the connected mode 1d-15, through an immediate MDT operation, MDT data may be collected and reported to a base station. In an embodiment, the UE 1d-05 that has transitioned to the connected mode 1d-15 may receive, from the base station, logged MDT configuration information performed in the idle mode or the inactive mode 1d-10 (1d-20). The UE 1d-05 may, for example, receive the logged MDT configuration information included in a predetermined RRC message. The UE 1d-05 that has received the RRC message may start a first timer (or T330) (1d-55). When the UE 1d-05 shifts to the idle mode or the inactive mode 1d-10, the UE 1d-05 may perform a logged MDT operation in an interval of the idle mode or the inactive mode 1d-10 until the first timer expires (1d-25). The value of the first timer may be included in the logged MDT configuration information.

The UE 1d-05 may store predetermined information collected per configured period, i.e., logging interval 1d-35 (1d-30, 1d-45). In addition, when valid location information 1d-40 is collected, the UE 1d-05 may also store the valid location information 1d-40. In an embodiment, the location information may be determined to be valid for a predetermined time (1d-50) after collecting the location information. The predetermined time may be shorter than or equal to the logging interval (or logged interval).

Even if the first timer has not yet expired, the UE 1d-05 stops the logged MDT operation, which was being performed, when transitioning to the connected mode 1d-15 (1d-60). The first timer may continue to run without stopping even during the interval of the connected mode 1d-15. The first timer may continue to run regardless of the change in RRC state of the UE 1d-05. However, the first timer may be stopped when a memory of the UE 1d-05 storing the MDT data is insufficient to store any more MDT data, or when the logged MDT configuration information is released. In an embodiment, when the logged MDT configuration information is released may be when different logged MDT configuration information is provided in serving RAT or another RAT, or when the UE 1d-05 is detached or power is cut off.

During an RRC connection establishment process or an RRC connection resume process, the UE 1d-05 may use an RRC setup complete message or an RRC resume complete message to report, to the base station, the availability of collected information (e.g., the MDT data) that the UE 1d-05 is storing (1d-65). In an embodiment, the UE 1d-05 may also use an RRC re-establishment complete or RRC reconfiguration complete message to report, to the base station, the availability of the collection information (e.g., MDT data) that the UE 1d-05 is storing (1d-65).

The RRC connection establishment process may be a process in which the UE 1d-05 shifts from the idle mode to the connected mode 1d-15. The process may include three steps, and three types of RRC messages may be used.
Step 1: The UE transmits an RRC setup request message to the base station.
Step 2: The base station transmits an RRC setup message to the UE
Step 3: The UE transmits an RRC setup complete message to the base station

The RRC connection resume process may be a process in which the UE 1d-05 shifts from the inactive mode 1d-10 to the connected mode 1d-15. As shown below, the process may include three steps, and three types of RRC messages may be used.
Step 1: The UE transmits an RRC resume request message to the base station.
Step 2: The base station transmits an RRC resume message to the UE.
Step 3: The UE transmits an RRC resume complete message to the base station.

The UE 1d-05 may report information indicating the availability of collected information to a target base station not only during the RRC connection establishment process or RRC connection resume process, but also during the RRC connection re-establishment process or a handover process. In an embodiment, when the logged MDT is configured but no information has yet been collected and stored, the UE 1d-05 may omit reporting. The base station receiving the report may, for example, request the reporting of the MDT data stored by the UE 1d-05 if necessary. The unreported MDT data may continue to be stored by the UE 1d-05 for a predetermined time.

When the UE 1d-05 transitions back to the idle mode or the inactive mode 1d-10, and when the first timer has not yet expired, the UE 1d-05 may restart the logged MDT operation (1d-70). When the first timer expires, the UE 1d-05 may stop the logged MDT operation (1d-75). After stopping the logged MDT operation, the UE 1d-05 may run a second timer (1d-80), and may retain the stored MDT data until the second timer expires. After the second timer expires, whether to delete the stored MDT data may be determined by the implementation of the UE 1d-05. The value of the second timer may be included in the logged MDT configuration information, or the value of the second timer may not be set and a predefined value may be applied.

In an embodiment, when the UE 1d-05 transitions back to the connected mode 1d-15, the UE 1d-05 may report, to the base station, the availability of collected information (e.g., MDT data) that the UE 1d-05 is storing (1d-85). The base station may, for example, use a predetermined RRC message to request (retrieve) the UE 1d-05 to report the stored MDT data (1d-90).

The UE 1d-05 may report a predetermined RRC message including the stored MDT data to the base station (1d-95).

FIG. 1E illustrates operations of collecting and reporting cell measurement information according to an embodiment of the disclosure.

Referring to FIG. 1E, in operation 1e-15, a UE 1e-05 may establish an RRC connection with a base station 1e-10.

In operation 1e-20, the UE 1e-05 may transmit UE capability information to a base station 1e-10. The UE capability information may, for example, include at least one of information about whether the UE 1e-05 supports MDT operation or information about what frequencies the UE 1e-05 is capable of measuring.

In operation 1e-25, the base station 1e-10 may transmit, to the UE 1e-05, a predetermined RRC message that includes configuration information required to perform a logged MDT operation. In an embodiment, the configuration information may include at least one of the following types of information.
Trace reference information
Trace recording session reference information
Trace collection entity (TCE) identity (ID) information: The base station may send MDT data information reported by the UE to a data server designated by a TCE ID.
Absolute time information (absolute time): The absolute time in a current cell that provides logged MDT configuration information
Area configuration: This is area information that allows for the collection and storage of measurement information by a logged MDT operation, and may be indicated on a per-cell basis. It may also include RAT information for which measurement information needs to be collected.
Logging duration: This is the value of a first timer, and the UE may perform a logged MDT operation in an idle mode or inactive mode when the timer is running.
Logging interval (or logged interval): This may be a period at which collected information is stored.
plmn-IdentityList (i.e., MDT PLMN list): This is PLMN list information, by which the UE may store PLMN information enabling not only performing the logged MDT operation but also reporting whether MDT data is stored and reporting the MDT data.
Indicator that indicates whether the UE performs the logged MDT operation in idle mode, inactive mode, or both. The indicator may indicate an RRC state in which the logged MDT operation is performed. Alternatively, without an indicator, the UE may be defined as always performing the logged MDT operations in both idle and inactive modes. The UE may only perform the logged MDT operation in the RRC state indicated by the indicator.
Indicator that indicates whether to collect and store beam-level measurement information. In a wireless communication system, a beam antenna may be employed. Without an indicator, it may be defined that a beam-level measurement result is always collected and stored for a frequency where a beam-based operation is performed.
Information about the maximum number of beams to be collected or stored, and information about the minimum signal strength of beams to be stored. The UE may omit the storage of information about beams having signal strength weaker than the minimum signal strength. When all beams are weaker than the configured minimum signal value, the UE may store information for one beam with the strongest signal strength, or may include an indicator indicating that all beams are weaker than the configured minimum signal value.
Indicator indicating whether an MDT retrieval operation may be triggered in a step 2 resume process (RRC Resume)

In operation 1e-30, the UE 1e-05 having received the logged MDT configuration information may start the first timer. The value of the first timer may be set to the same value as the logging duration.

In operation 1e-35, the base station 1e-10 may transition the UE 1e-05 into the idle or inactive mode by using an RRC release message. Depending on an RRC state to which transition is performed, the RRC release message may include configuration information for an operation in the RRC state.

In operation 1e-40, when the first timer is running, the UE 1e-05 may perform the logged MDT in the idle or inactive mode. The signal strength of a serving cell and neighboring cells may, for example, be measured, and location information may be obtained. When beam level measurement is configured, the UE 1e-05 may collect and store signal strength values for beams greater than a configured minimum value in the serving cell and the neighboring cells. In an embodiment, the maximum number of beams capable of being stored may also be configured or predefined. In an embodiment, the signal strength may refer to reference signal received power (RSRP), reference signal received quality (RSRQ), or signal to interference noise ratio (SINR). The UE 1e-05 may store the collected information per logging interval period. Each piece of log information stored per period may include an indicator indicating whether the stored information was collected in the idle mode or was collected in the inactive mode. In an embodiment of the disclosure, an indicator may be included in each initial log at which a mode is transitioned. According to embodiments described above, signaling overhead due to the indicator may be minimized.

In operations 1e-45 and 1e-50, when the first timer expires, the UE 1e-05 may stop the logged MDT operation. For example, when the UE 1e-05 is in the idle or inactive mode based on the RRC Release message and receives RAN or CN paging from the base station or when MO data transmission is activated, the UE 1e-05 may initialize the establishment process or the resume process for transition from the idle or inactive mode to the connected mode.

The establishment process or resume process may be configured as follows:
Operation 1 (1e-55): The UE sends an RRC setup request message or an RRC resume request message to the base station.
Operation 2 (1e-60): The base station sends an RRC setup message or an RRC resume message to the UE.
Operation 3 (1e-65): The UE sends an RRC setup complete message or an RRC resume complete message to the base station.

The UE 1e-05 may include, in the RRC setup complete or RRC resume complete message, an indicator indicating the availability of the MDT data which the UE 1e-05 is storing.

In operation 1e-70, if necessary, the base station 1e-10 having received the RRC setup complete message may, for example, request (retrieve) reporting of the MDT data by using a predetermined RRC message (1e-70).

In operation 1e-75, the UE 1e-05 having received the request may report the MDT data by using a predetermined RRC message.

An NR system may perform a signaling-based procedure or a management-based procedure to activate quality of experience (QoE) measurement.

FIG. 1F is a flowchart illustrating a procedure for configuring and/or reporting signaling-based QoE measurement according to an embodiment of the disclosure.

Referring to FIG. 1F, a UE access stratum (AS) 1f-05 may transmit information, which indicates whether the UE AS 1f-05 supports QoE measurement by service type (e.g., at least one of streaming, MTSI, or VR) (e.g., at least one of, qoe-Streaming-MeasReport, qoe-MTSI-MeasReport, or qoe-VR-MeasReport), to a base station (or, NG-RAN) 1f-15 via a UE capability message (e.g., UECapabilityInformation) (1f-10). Before sending the UE capability message, the base station may send a message (e.g., UECapabilityEnquiry) regarding a request for the UE capability message. Additionally, through the UE capability message, the UE may report, to the base station, whether the UE supports RAN visible QoE measurement (e.g., at least one of ran-VisibleQoE-Streaming-MeasReport or ran-VisibleQoE-VR-MeasReport) by service type (e.g., streaming, VR). In addition, through the UE capability message, the UE may report whether the UE supports UL RRC segmentation for a QoE report message (e.g., ul-MeasurementReportAppLayer-Seg). The UE capability message may, for example, include the following ASN.1 information and related parameter descriptions.

QoE-Parameters-r17 ::= SEQUENCE {

| | |
|---|---|
| qoe-Streaming-MeasReport-r17 | ENUMERATED {supported} |
| OPTIONAL, | |
| qoe-MTSI-MeasReport-r17 | ENUMERATED {supported} |
| OPTIONAL, | |
| qoe-VR-MeasReport-r17 | ENUMERATED {supported} |
| OPTIONAL, | |
| ran-VisibleQoE-Streaming-MeasReport-r17 | ENUMERATED |
| {supported} OPTIONAL, | |
| ran-VisibleQoE-VR-MeasReport-r17 | ENUMERATED {supported} |
| OPTIONAL, | |
| ul-MeasurementReportAppLayer-Seg-r17 | ENUMERATED |

{supported} OPTIONAL,

```
    ...
  }
```

4.2.20 QoE Measurement Parameters

TABLE 2

| | | | FDD-TDD | FR1-FR2 |
|---|---|---|---|---|
| Definitions for parameters | Per | M | DIFF | DIFF |
| qoe-Streaming-MeasReport-r17 | UE | No | No | No |
| Indicates whether the UE supports NR QoE | | | | |
| Measurement Collection for streaming services, see | | | | |
| TS 26.247 [29]. | | | | |
| qoe-MTSI-MeasReport-r17 | UE | No | No | No |
| Indicates whether the UE supports NR QoE | | | | |
| Measurement Collection for MTSI services, see TS | | | | |
| 26.114 [30]. | | | | |
| qoe-VR-MeasReport-r17 | UE | No | No | No |
| Indicates whether the UE supports NR QoE | | | | |
| Measurement Collection for VR services, see TS | | | | |
| 26.118 [31]. | | | | |
| ran-VisibleQoE-Streaming-MeasReport-r17 | UE | No | No | No |
| Indicates whether the UE supports RAN visible QoE | | | | |
| Measurement Collection for streaming services. | | | | |
| ran-VisibleQoE-VR-MeasReport-r17 | UE | No | No | No |
| Indicates whether the UE supports RAN visible QoE | | | | |
| Measurement Collection for VR services. | | | | |
| ul-MeasurementReportAppLayer-Seg-r17 | UE | No | No | No |
| Indicates whether the UE supports RRC | | | | |
| segmentation of the MeasurementReportAppLayer | | | | |
| message in UL, as specified in TS 38.331 [9]. | | | | |

Service types capable of being supported by LTE may include streaming and multimedia telephony service for IP multimedia subsystem (IMS) (MTSI). The NR system may additionally support virtual reality (VR) in addition thereto, as defined in Rel-17, and may additionally support multimedia broadcast multicast services (MBMS), extended reality (XR), etc. in future releases. The disclosure is not limited to the above examples.

According to an embodiment, operations administration and maintenance (OAM) 1f-20 may provide QoE measurement configuration information to a core network (CN) 1f-25 (1f-30). The CN having received the configuration information may activate QoE measurement by transmitting the configuration information to a base station (1f-35). In an embodiment, the base station having received the configuration information may transmit the QoE configuration information to the UE AS via an RRC message (e.g., an RRC reconfiguration or RRC resume message) (1f-40). The RRC message may include the following information elements (IEs) (e.g., APPLayerMeasConfig), and related parameter descriptions may be as follows. Hereafter, QoE measurement configuration information may be used interchangeably with QoE configuration information.
AppLayerMeasConfig

The IE AppLayerMeasConfig indicates configuration of application layer measurements(IE AppLayerMeasConfig).

AppLayerMeasConfig information element

```
  -- ASN1START
  -- TAG-APPLAYERMEASCONFIG-START
  AppLayerMeasConfig-r17 ::= SEQUENCE {
```

| | |
|---|---|
| measConfigAppLayerToAddModList-r17 | SEQUENCE (SIZE |
| (1..maxNrofAppLayerMeas-r17)) OF MeasConfigAppLayer-r17 | OPTIONAL, -- |
| Need N | |
| measConfigAppLayerToReleaseList-r17 | SEQUENCE (SIZE |
| (1..maxNrofAppLayerMeas-r17)) OF MeasConfigAppLayerId-r17 | OPTIONAL, -- |
| Need N | |
| rrc-SegAllowed-r17 | ENUMERATED {enabled} |

```
OPTIONAL, -- Need R
    ...
  }
```

| | |
|---|---|
| MeasConfigAppLayer-r17 ::= | SEQUENCE { |
| measConfigAppLayerId-r17 | MeasConfigAppLayerId-r17 |

| | |
|---|---|
| measConfigAppLayerContainer-r17 | OCTET STRING (SIZE |

(1..8000)) OPTIONAL, -- Need N

| | |
|---|---|
| serviceType-r17 | ENUMERATED {streaming, mtsi, vr, |

spare5, spare4, spare3, spare2, spare1} OPTIONAL, -- Need M
pauseReporting BOOLEAN OPTIONAL, -- Need M

| | |
|---|---|
| transmissionOfSessionStartStop | BOOLEAN OPTIONAL, -- Need |
| M | |
| ran-VisibleParameters-r17 | SetupRelease {RAN- |

VisibleParameters-r17} OPTIONAL, -- Need M

| ... | | |
|---|---|---|
| } | | |
| RAN-VisibleParameters-r17 ::= | SEQUENCE { | |
| ran-VisiblePeriodicity-r17 | | ENUMERATED {ms120, ms240, |

ms480, ms640, ms1024} OPTIONAL, -- Need S

| | |
|---|---|
| numberOfBufferLevelEntries-r17 | INTEGER (1..8) OPTIONAL, |
| -- Need R | |

| | |
|---|---|
| reportPlayoutDelayForMediaStartup-r17 BOOLEAN | OPTIONAL, - |

```
- Need M
    ...
  }
```

```
  -- TAG-APPLAYERMEASCONFIG-STOP
  -- ASN1STOP
```

TABLE 3
AppLayerMeasConfig field descriptions
measConfigAppLayerContainer
The field contains configuration of application layer measurements, see Annex L
(normative) in TS 26.247 [68], clause 16.5 in TS 26.114 [69] and TS 26.118 [70].
pauseReporting
The field indicates whether the transmission of
MeasurementReportAppLayerContainer is paused or not.
Ran-VisibleParameters
The field indicates whether RAN visible application layer measurements shall be
reported or not. The field is optionally present when serviceType is set to streaming
or vr. Otherwise, it is absent.
Rrc-SegAllowed
This field indicates that RRC segmentation of MeasurementReportAppLayer is
allowed. It may be present only if the UE supports RRC segmentation of the
MeasurementReportAppLayer message in UL.
serviceType
Indicates the type of application layer measurement. Value streaming indicates
Quality of Experience Measurement Collection for streaming services (see TS
26.247 [68]), value mtsi indicates Quality of Experience Measurement Collection
for MTSI (see TS 26.114 [69]). Value vr indicates Quality of Experience
Measurement Collection for VR service (see TS 26.118 [70]). The network always
configures serviceType when application layer measurements are initially
configured and at fullConfig.
transmissionOfSessionStartStop
The field indicates whether the UE shall transmit indications when sessions in the
application layer start and stop. The UE transmits a session start indication upon
configuration of this field if a session already has started in the application layer.

TABLE 4

RAN-VisibleParameters field descriptions
numberOfBufferLevelEntries
The field contains the maximum number of buffer level entries that
can be reported for RAN visible application layer measurements.
ran-VisiblePeriodicity
The field indicates the periodicity of RAN visible reporting. Value
ms120 indicates 120 ms, value ms240 indicates 240 ms and so on.
reportPlayoutDelayForMediaStartup
The field indicates whether the UE shall report Playout Delay for
Media Startup for RAN visible application layer measurements.

The operation of the UE AS having received the RRC message may be as follows.

5.3.5.13d Application Layer Measurement Configuration

The UE shall:
1> if measConfigAppLayerToReleaseList is included in appLayerMeasConfig within RRCReconfiguration or RRCResume:
2> for each measConfigAppLayerId value included in the measConfigAppLayerToReleaseList:
3> forward the measConfigAppLayerId and inform upper layers about the release of the application layer measurement configuration including any RAN visible application layer measurement configuration;
3> discard any application layer measurement report received from upper layers;
3> consider itself not to be configured to send application layer measurement report for the measConfigAppLayerId.
1> if measConfigAppLayerToAddModList is included in appLayerMeasConfig within RRCReconfiguration or RRCResume:
2> for each measConfigAppLayerId value included in the measConfigAppLayerToAddModList:
3> if measConfigAppLayerContainer is included for the corresponding MeasConfigAppLayer configuration:
4> forward the measConfigAppLayerContainer, the measConfigAppLayerId and the serviceType to upper layers considering the serviceType;
3> consider itself to be configured to send application layer measurement report for the measConfigAppLayerId in accordance with 5.7.16;
3> forward the transmissionOfSessionStartStop, if configured, and measConfigAppLayerId to upper layers considering the serviceType;
3> if ran-VisibleParameters is set to setup and the parameters have been received:
4> forward the measConfigAppLayerId, the ran-VisiblePeriodicity, if configured, the numberOfBufferLevelEntries, if configured, and the reportPlayoutDelayForMediaStartup, if configured, to upper layers considering the serviceType;
3> else if ran-VisibleParameters is set to release:
4> forward the measConfigAppLayerId and inform upper layers about the release of the RAN visible application layer measurement configuration;
3> if pauseReporting is set to true:
4> if at least one segment, but not all segments, of a segmented MeasurementReportAppLayer message containing an application layer measurement report associated with the measConfigAppLayerId has been submitted to lower layers for transmission:
5> submit the remaining segments of the MeasurementReportAppLayer message to lower layers for transmission;
4> suspend submitting application layer measurement report containers to lower layers for the application layer measurement configuration associated with the measConfigAppLayerId;
4> store any previously or subsequently received application layer measurement report containers associated with the measConfigAppLayerId for which no segment, or full message, has been submitted to lower layers for transmission;
3> else if pauseReporting is set to false and if transmission of application layer measurement report containers has previously been suspended for the application layer measurement configuration associated with the measConfigAppLayerId:
4> submit stored application layer measurement report containers to lower layers, if any, for the application layer measurements configuration associated with the measConfigAppLayerId;
4> resume submitting application layer measurement report containers to lower layers for the application layer measurement configuration associated with the measConfigAppLayerId;

NOTE 1: The UE may discard reports when the memory reserved for storing application layer measurement reports becomes full.

NOTE 2: The transmission of RAN visible application layer measurement reports is not paused when pauseReporting is set to true.

As described above, for the QoE measurement configuration included in measConfigAppLayerToAddModList, the UE AS layer may transmit the configuration information to an upper layer or an application layer (UE APP) 1f-45 of the UE via an AT command (1f-50). For the QoE measurement configuration included in measConfigAppLayerToAddReleaseList, the UE AS layer may send, to the UE APP, an AT Command to delete stored configuration information. The UE AS layer may be used interchangeably with UE AS in this disclosure. Also, UE APP layer may be used interchangeably with UE APP or UE application layer in this disclosure.

The UE APP may perform QoE measurement based on the received configuration information. Additionally, the UE APP may report the result of the measurement to the UE AS via an AT command, based on the configuration information (1f-55). After receiving the AT command, the UE AS may report the measurement result to the base station via an RRC message (e.g., a MeasurementReportAppLayer message) (1f-60). The UE AS may use SRB4 to report the QoE measurement result. The MeasurementReportAppLayer message may include the following ASN.1 information and related parameter descriptions.

MeasurementReportAppLayer

The MeasurementReportAppLayer message is used for sending application layer measurement report.

Signalling radio bearer: SRB4

RLC-SAP: AM

Logical channel: DCCH

Direction: UE to Network

MeasurementReportAppLayer message

```
  -- ASN1START
  -- TAG-MEASUREMENTREPORTAPPLAYER-START
  MeasurementReportAppLayer-r17 ::= SEQUENCE {
    criticalExtensions CHOICE {
      measurementReportAppLayer-r17
MeasurementReportAppLayer-r17-IEs,
```

| criticalExtensionsFuture | SEQUENCE { } |
|---|---|
| } | |
| } | |

```
  MeasurementReportAppLayer-r17-IEs ::= SEQUENCE {
    measurementReportAppLayerList-r17
MeasurementReportAppLayerList-r17,
```

| lateNonCriticalExtension | OCTET STRING OPTIONAL, | |
|---|---|---|
| nonCriticalExtension | SEQUENCE{ } OPTIONAL | |
| } | | |
| MeasurementReportAppLayer-r17 ::= | | SEQUENCE (SIZE |

(1..maxNrofAppLayerMeas-r17)) OF MeasurementReportAppLayer-r17
MeasurementReportAppLayer-r17 ::= SEQUENCE {

| measConfigAppLayerId-r17 | MeasConfigAppLayerId-r17, | |
|---|---|---|
| MeasurementReportAppLayerContainer-r17 | | OCTET STRING |
| OPTIONAL, | | |
| appLayerSessionStatus-r17 | | ENUMERATED {started, stopped} |
| OPTIONAL, | | |
| ran-VisibleMeasurements-r17 | | RAN-VisibleMeasurements-r17 |
| OPTIONAL | | |
| } | | |
| RAN-VisibleMeasurements-r17 ::= | SEQUENCE { | |
| appLayerBufferLevelList-r17 | | SEQUENCE (SIZE (1..8)) OF |

AppLayerBufferLevel-r17 OPTIONAL,

| playoutDelayForMediaStartup-r17 | INTEGER (0..30000) |
|---|---|
| OPTIONAL, | |
| pdu-SessionIdList-r17 | SEQUENCE (SIZE (1..maxNrofPDU- |

Sessions-r17)) OF PDU-SessionID OPTIONAL,

```
    ...
  }
```

```
  AppLayerBufferLevel-r17 ::= INTEGER (0..30000)
  -- TAG-MEASUREMENTREPORTAPPLAYER-STOP
```

-- ASN1STOP

TABLE 5
MeasurementReportAppLayer field descriptions
appLayerBufferLevelList
The field indicates a list of application layer buffer levels, and each
AppLayerBufferLevel indicates the application layer buffer level in ms. Value 0
corresponds to 0 ms, value 1 corresponds to 10 ms, value 2 corresponds to 20 ms and
so on. If the buffer level is larger than the maximum value of 30000 (5 minutes),
the UE reports 30000.
appLayerSessionStatus
Indicates that an application layer measurement session in the application layer
starts or ends.
playoutDelayForMediaStartup
Indicates the application layer playout delay for media start-up in ms. Value 0
corresponds to 0 ms, value 1 corresponds to 1 ms, value 2 corresponds to 2 ms and so
on. If the playout delay for media start-up is larger than the maximum value of
30000 ms, the UE reports 30000.
MeasurementReportAppLayerContainer
The field contains application layer measurement report, see Annex L (normative) in
TS 26.247 [68], clause 16.5 in TS 26.114 [69] and TS 26.118 [70].
pdu-SessionIdList
Contains the identity of the PDU session, or the identities of the PDU sessions, used
for application data flows subject to the RAN visible application layer
measurements.

The procedure by which the UE AS reports the result of the QoE measurement may be as follows.

5.7.16 Application layer measurement reporting

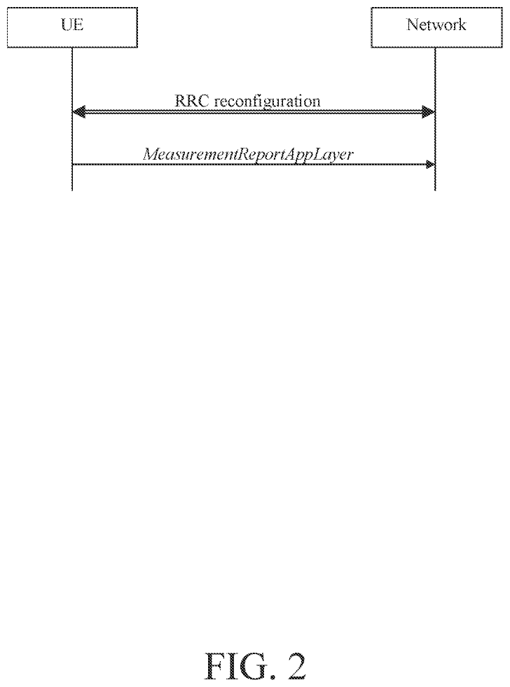

5.7.16.1 General (see FIG. 2 which illustrates communication between a user equipment and a network).

The purpose of this procedure is to send application layer measurement reports to the network.

5.7.16.2 Initiation

A UE capable of application layer measurement reporting in RRC_CONNECTED may initiate the procedure when configured with application layer measurement, i.e. when appLayerMeasConfig and SRB4 have been configured by the network.

Upon initiating the procedure, the UE shall:
1> for each measConfigAppLayerId:
2> if the UE AS has received application layer measurement report from upper layers which has not been transmitted; and
2> if the application layer measurement reporting has not been suspended for the measConfigAppLayerId associated with the application layer measurement report according to clause 5.3.5.13d:
3> set the MeasurementReportAppLayerContainer in the MeasurementReportAppLayer message to the received value in the application layer measurement report;
2> set the measConfigAppLayerId in the MeasurementReportAppLayer message to the value of the measConfigAppLayerId received together with application layer measurement report information;
2> if session start or stop information has been received from upper layers for the measConfigAppLayerId:
3> set the appLayerSessionStatus to the received value of the application layer measurement information;
2> if RAN visible application layer measurement report has been received from upper layers:
3> for each appLayerBufferLevel value in the received RAN visible application layer measurement report:
4> set the appLayerBufferLevel values in the appLayerBufferLevelList to the buffer level values received from the upper layer in the order with the first appLayerBufferLevel value set to the newest received buffer level value, the second appLayerBufferLevel value set to the second newest received buffer level value, and so on until all the buffer level values received from the upper layer have been assigned or the maximum number of values have been set according to appLayerBufferLevel, if configured;
3> set the playoutDelayForMediaStartup to the received value in the RAN visible application layer measurement report, if any;
3> for each PDU session ID value indicated in the received RAN visible application layer measurement report, if any:
4> set the PDU-SessionID field in the pdu-SessionIdList to the indicated PDU session ID value;
2> if the encoded RRC message is larger than the maximum supported size of one PDCP SDU specified in TS 38.323 [5]:
3> if the RRC message segmentation is enabled based on the field rrc-SegAllowed received in appLayerMeasConfig:
4> initiate the UL message segment transfer procedure as specified in clause 5.7.7;
3> else:
4> discard the RRC message;
2> else:
3> submit the MeasurementReportAppLayer message to lower layers for transmission upon which the procedure ends.

The base station may transmit a measurement result report to a final server (TCE or MCE) 1f-65 that collects measurement reports (1f-70).

FIG. 1G is a flowchart illustrating a procedure for configuring and/or reporting management-based QoE measurement according to an embodiment of the disclosure.

Referring to FIG. 1G, the management-based QoE configuration and/or reporting procedure may be similar to a signaling-based procedure (e.g., FIG. 1F). In the disclosure, only the differences related to the management-based approach may be described, and other procedures and descriptions may be identical to those described with reference to FIG. 1F. In the management-based approach, OAM 1g-05 may activate QoE measurement by sending QoE measurement configuration directly to a base station 1g-10 without going through a CN (1g-15). In an embodiment, the base station having received the QoE measurement configuration may locate a single UE or multiple UEs that meet multiple conditions (e.g., at least one of area scope, application layer capability, or service type). The base station may, for example, then transmit the QoE measurement configuration to each of the UEs via an RRC message (e.g., an RRC reconfiguration message or an RRC resume message) (1g-20). Other procedures and message formats may be the same as those described with reference to FIG. 1F (signaling-based method)

FIG. 1H is a flowchart illustrating a procedure for configuring and reporting RAN visible QoE measurement according to an embodiment of the disclosure.

Referring to FIG. 1H, the QoE measurement described with reference to FIGS. 1F and 1G may be configured by the OAM, the QoE measurement report generated based on the OAM's configuration may be collected by the TCE/MCE, and the provider may use the QoE measurement report for network optimization. In an embodiment, the UE may transmit a report on OAM-based QoE measurement to the base station, and when the base station receives the report on OAM-based QoE measurement, the base station may have difficulty reading or understanding the measurement report. The measurementReportAppLayer message may include a measurement report generated by the UE's application layer in measurementReportAppLayerContainer. Because the measurement report is stored as an OCTEC STRING format, it may be difficult for the base station or the base station's RRC layer to read or understand the measurement report. RAN visible QoE (e.g., RVQoE) measurement was defined and introduced by 3GPP to address the difficulty of reading and understanding a measurement report, thereby enabling base stations to read a QoE measurement report and use the same for network optimization, such as radio resource management. The RVQoE measurement may, for example, be defined to be limited to a specific service type (e.g., at least one of streaming or VR). First, the UE may report to the base station whether the UE supports RVQoE measurement by service type (e.g., at least one of streaming or VR) (1h-05). In this case, a UECapabilityInformation message may be used. For example, with respect to a streaming service, the UE may include or configure an ran-VisibleQoE-Streaming-MeasReport parameter in the UECapabilityInformation message, and with respect to a VR service, the UE may include or configure an ran-VisibleQoE-VR-MeasReport parameter. In an embodiment, the inclusion or configuration of the parameter by the UE enables the base station to determine whether the UE supports RVQoE measurement by service type, and based upon determining whether the UE supports RVQoE measurement by service type, the base station may generate RVQoE measurement configuration and transmit the RVQoE measurement configuration to the UE (1h-10). In this case, the RVQoE measurement configuration may be transmitted together with OAM-based QoE measurement configuration. The RVQoE measurement configuration may be included in an RRCReconfiguration or RRCResume message. The base station may, for example, use the setup or release of ran-VisibleParameters in AppLayerMeasConfig IE to instruct the UE to configure or release RVQoE measurement. The parameters may include RAN-VisibleParameters IE, and the base station may provide the UE with some or all of the parameters through the RAN-VisibleParameters IE.

RVQoE measurement reporting period (e.g., ran-VisiblePeriodicity): A UE AS or a UE APP may send an RVQoE measurement report on a periodic basis.

Maximum number of reportable buffer levels (e.g., numberOfBufferLevelEntries): The UE AS or UE APP may include multiple buffer levels in the reporting of RVQoE measurement, wherein the number of buffer levels may be less than or equal to a predetermined value.

Whether to report playout delay for media startup (e.g., reportPlayoutDelayForMediaStartup): When a value of whether to report playout delay for media startup is indicated as true, the UE AS or UE APP may include the playout delay for media startup in an RVQoE report and transmit the RVQoE report. For example, when the value of whether to report playout delay for media startup is indicated as false, the UE may not include the playout delay for media startup in the RVQoE report.

The UE AS layer may transmit the above-described configuration information to the UE APP layer (1h-15). The RVQoE measurement configuration may be transmitted together with the OAM-based QoE measurement configuration. The UE APP may perform QoE measurement based on RVQoE measurement configuration information to generate an RVQoE measurement report, and may transmit the generated RVQoE measurement report to the UE AS layer (1h-20). The RVQoE measurement report may be transmitted together with an OAM-based QoE measurement report. The UE AS layer that has received the RVQoE measurement report may transmit the RVQoE measurement report to the base station (1h-25). In this case, the RVQoE measurement report may be delivered together with the OAM-based QoE measurement report. In 1h-25, the RVQoE measurement report may be transmitted via an RAN-VisibleMeasurements IE in a MeasurementReportAppLayer message. The RAN-VisibleMeasurements IE may include some or all of the following parameters.

A list of buffer levels of the APP layer (e.g., appLayerBufferLevelList): The buffer level list of the APP layer may include multiple buffer levels measured by the UE APP. In an embodiment, the number of buffer levels that are included may be limited by numberOfBufferLevelEntries in RVQoE configuration.

Playout delay (e.g., playoutDelayForMediaStartup): Playout delay for media startup may be indicated in ms. The UE may include the playout delay parameter when reportPlayoutDelayForMediaStartup is configured to be true in the RVQoE configuration.

PDU session ID list (e.g., pdu-SessionIdList): The PDU session ID list may indicate PDU session(s) used in application data flow targeted for RVQoE measurement. The base station may, for example, use the PDU session ID list to know PDU session(s) for which RVQoE values (e.g., buffer level and playout delay) have been measured, and may optimize resource allocation and scheduling, based on the PDU session(s) for which RVQoE values (e.g., buffer level and playout delay) have been measured.

The base station may, for example, read the RVQoE report, and may use the RVQoE report to perform network optimization. For example, the base station may improve the QoE of a UE that is experiencing poor QoE for a particular service by allocating a greater amount of radio resources to that UE.

At the 3GPP meeting, RAN2/3 reached the following agreement to be introduced into NR for QoE measurement.

RAN3 #109e
NR QoE management supports following service types:
   Streaming video: TS 26.247
   VR: TS 26.118
   MTSI: TS 26.114
   MBMS: TS 26.347

RAN3 #111e
Support XR as new service type for QoE measurement

RAN2 #113e
QoE measurements in RRC INACTIVE state can be supported, for MBS.
QoE measurements in RRC IDLE state can be supported, for MBS.

In the LTE system, QoE measurement (e.g., as described with respect to FIGS. 1F and 1G) may be supported only in a connected mode (RRC_CONNECTED). On the other hand, the NR system may support QoE measurement even in an inactive mode (RRC_INACTIVE) or an idle mode (RRC_IDLE) for multimedia broadcast multicast services (MBMS) or multicast/broadcast services (MBS). The NR system may support QoE measurement in the inactive and idle modes not only for MBS but also for various service types.

FIG. 1I illustrates operations performed between a base station and a UE AS for QoE measurement according to an embodiment of the disclosure.

Referring to FIG. 1I, FIG. 1I may illustrate a method for performing QoE measurement in inactive and idle modes. Specifically, the overall procedure among all entities (at least one of the TCE/MCE, OAM, NG-RAN, UE AS, or UE APP) may be based on the procedures and descriptions in FIGS. 1F and 1G. FIG. 1I may focus on illustrating a signaling procedure between a base station (or NG-RAN) 1i-05 and a UE AS 1i-10 and an operation based on the signaling procedure.

In operation 1i-15, the UE 1i-10 may establish an RRC connection with the base station 1i-05.

In operation 1i-20, the UE 1i-10 may provide UE capability information to the base station 1i-05. The UE 1i-10 may, for example, report a QoE-related capability (UE capability) to the base station for each type of service supported by the UE 1i-10, as in FIGS. 1F and 1G.

In operation 1i-25, the base station 1i-05 may transmit, to the UE 1i-10, logged QoE measurement configuration information for QoE measurement in an inactive and/or idle mode, received from OAM or CN. In an embodiment, the configuration information may include some or all of the following pieces of information.
A container that contains application layer QoE measurement configuration information in an inactive and/or idle mode. Application layer QoE measurement configuration information in a connected mode (e.g., measConfigAppLayerContainer) may be reused. In addition, the container may be configured separately from the application layer QoE measurement configuration in the connected mode.
Service type. It may be specified what type of service the logged QoE measurement configuration is for.
ID to identify the QoE measurement configuration at an RRC level: The ID to identify the QoE measurement configuration at the RRC level may be included in RRC signaling at the time of QoE measurement configuration and measurement reporting. For example, when the RRC level ID is set to 1 at the time of QoE measurement configuration, a UE's AS layer or application layer may include an RRC level ID as 1 in a QoE measurement report generated by the QoE measurement configuration. The RRC level ID may then be mapped by the base station to a QoE Reference (a value for distinguishing the QoE measurement configuration at an OAM or CN or TCE/MCE level). For example, a base station that has received a QoE measurement configuration with a QoE reference set to 351 may map the QoE measurement configuration to RRC level ID 3 and store the mapping. Then, the base station may transmit QoE measurement configuration information containing the RRC level ID 3 to a UE. The UE may, for example, include the RRC level ID 3 in a QoE measurement report generated using the QoE measurement configuration information and send the same to the base station, and the base station may determine that the RRC level ID 3 is mapped to the QoE reference 351 and transmit the QoE measurement report including the QoE reference 351 to at least one of the OAM, CN, or TCE/MCE. In an embodiment of the disclosure, the QoE measurement configuration information may include at least one of the following pieces of information.
Trace reference information
Trace recording session reference information
TCE (trace collection entity) ID information: The base station may transmit QoE data information reported by the UE to a data server specified by a TCE ID.
Absolute time information (absolute time): Absolute time in a current cell that provides information about the logged QoE measurement configuration. Time information may be used to correlate an MDT measurement result with a QoE measurement result.
Area configuration: This is area information where measurement information may be collected and stored through a logged QoE measurement operation, and may be indicated by a cell unit and/or PLMN.
Logging duration: This may be a period of time indicating the time during which logged QoE configuration information is valid. The UE may start one timer when receiving the logged QoE configuration information, and may log a QoE report from the application layer while the timer is running. The timer may, for example, expire when the base station releases the logged QoE configuration information or when the logging duration period expires, and thereafter, the UE may not log the QoE report from the application layer.
Logged data validity time: This may indicate the validity time of logged data received from the application layer. The UE AS layer may, for example, start one timer when QoE data information is received from the application layer and logged. The timer may run on a per-data basis. The UE AS layer may log QoE data while the timer is running. When the logged data validity time passes or the timer expires (by the base station), the UE may not additionally log QoE data from the application layer.
Retrieval validity time: This may indicate the retrieval validity time of data received from the application layer. The UE AS layer may start one timer when QoE data information is received from the application layer and logged. The timer may run on a per-data basis. Alternatively, the timer may, for example, start at the moment the UE receives the configuration. The timer may also run for each service type, and the timer duration may vary. While the timer is running, the UE may report the logged data when the base station makes a retrieval request. While the timer is running, the UE may store a corresponding QoE measurement result report. When the retrieval validity time has passed or the timer has expired (by the base station), the UE may not report the logged data even if the base station makes a retrieval request. Alternatively, when the timer expires, the UE may discard the logged data to free up a memory.
Report validity time: This may indicate the report validity time of data received from the application layer. The UE may start a timer when QoE data information is received from the application layer and logged. The timer may, for example, run on a per-data basis. In one embodiment, the timer may start at the moment the UE receives the configuration. The timer may start for each service type, and the timer duration may vary. While the timer is running, the UE may report the logged data. When the report validity time passes or the timer expires by the base station, the UE may not report logged data afterward.
plmn-IdentityList (i.e., logged QoE PLMN list): This is PLMN list information, which may include PLMN information that that may be used to perform a logged QoE measurement operation, report the availability of logged QoE data, and report the logged QoE data.
An indicator that indicates whether to perform a logged QoE measurement operation in at least one of an idle mode or an inactive mode. The indicator may also indicate an RRC state in which the logged QoE measurement operation is performed. Alternatively, it may be defined that the logged QoE measurement operation is always performed in the idle mode and the inactive mode without any indicator. In an embodiment, the UE may only perform the logged QoE measurement operation in the RRC state indicated by the indicator. When the logged QoE measurement operation is performed in a connected mode, the indicator may indicate and/or extend to include the connected mode.
Report type: This may specify a type in which the UE should report (e.g., periodically or whenever an event occurs). In the case of periodic reporting, the UE may report whenever there is logged QoE data on a periodic basis. In the case of event-based reporting, the UE may report logged QoE data when a specific event (e.g., decreased throughput or increased delay) occurs in application layer measurement or when the UE receives an indicator indicating that a specific event has occurred.
Threshold for QoE data size: The UE may report to the base station only when a logged data size exceeds a threshold. In an embodiment, the threshold may also be applied on a per-service-type basis. That is, the UE may report to the base station only when a logged data size for one service type exceeds a threshold for the service type.
Threshold for the number of pieces of QoE data: The UE may report to the base station only when the number of pieces of logged data exceeds a threshold. The threshold may, for example, also be applied on a per-service-type basis. That is, the UE may report to the base station only when the number of pieces of logged data for one service type exceeds a threshold for the service type.
Indicator indicating whether to directly measure, store, or report QoE: When the indicator is configured, the UE may measure, store, or report QoE in a corresponding cell.

In one embodiment of the disclosure, the configuration information may be indicated separately for the idle mode and the inactive mode. In an embodiment of the disclosure, multiple pieces of configuration information (e.g., multiple pieces of configuration information per service type or per priority) may be designated.

The priority may be a value determined by the application layer for each piece of QoE measurement data and communicated to the AS. In an example, when degraded performance is measured for a specific performance indicator such as throughput or delay, the UE application layer may assign a low priority to relevant data. When degraded performance has not been measured for a specific performance indicator such as throughput or delay, the UE application layer may assign a high priority and notify the UE AS of the high priority. At this time, the UE application layer may transmit the priority to the UE AS together with corresponding QoE data through an AT command. The priority may, for example, be configured for each piece of QoE data, or an average priority may be configured for multiple pieces of QoE data. In an embodiment of the disclosure, multiple priorities may be specified within one piece of QoE data. A data UE may store the configuration information as a UE variable.

The base station 1i-05 may include the QoE measurement configuration information in a dedicated message such as the following, and transmit the message to the UE.
RRC release message: The base station may use an RRC release message to transition the UE to an inactive mode and/or an idle mode, and the RRC release message may include QoE measurement configuration information.
Logged measurement configuration message: This is a message including configuration information for a logged MDT, and may include QoE measurement configuration information separately from the configuration information for the logged MDT. Alternatively, the configuration information for the logged MDT and the QoE measurement configuration information may share common information.
RRC reconfiguration message: This may be configured together with QoE measurement configuration information in the previous connected mode. Alternatively, the message may be configured separately from the QoE measurement configuration information in the previous connected mode. When the UE transitions to RRC_INACTIVE or RRC_IDLE, the QoE measurement configuration information may be stored instead of being discarded, and may be used for QoE measurement.
In addition, existing dedicated downlink RRC message
New dedicated RRC message: A new message (e.g., for logged QoE measurement configuration) may be defined.

The base station 1i-05 may include the QoE measurement configuration information in a broadcast message such as the following, and transmit the message to the UE.
SIB
Multicast control channel (MCCH): This is a channel for transmitting an MBMS service-related control message, and the MCCH may be reused to transmit QoE measurement configuration information.

In an embodiment of the disclosure, one RRC message may include multiple pieces of QoE measurement configuration information.

The UE AS layer may transmit the QoE configuration information received in operation 1i-25 to the application layer (APP), and the UE APP may perform QoE measurement based on the QoE configuration information.

In operation 1i-30, the UE having received the logged QoE measurement configuration information may release the RRC connection. When the UE transitions to the idle mode and/or the inactive mode, the UE may, for example, store the logged QoE measurement configuration information without releasing logged QoE measurement configuration. In an embodiment, the UE application layer in the idle or inactive mode may perform QoE measurement based on the stored configuration information and report the measurement result to the UE AS 1i-10.

In operation 1i-35, the UE AS 1i-10 may log the result of the QoE measurement performed based on the configuration information in the inactive or idle mode.

In operation 1i-40, the UE AS 1i-10 may re-establish a connection with a new base station. In one embodiment, when establishing the RRC connection, the UE may report the availability of the UE's QoE data logging to the base station 1i-05 by using the following messages.
RRC re-establishment complete
RRC reconfiguration complete
RRC resume complete
RRC setup complete

In an embodiment of the disclosure, operations 1i-30 and 1i-40 may be omitted. That is, even in an RRC connection mode, the UE may report to the base station by logging. In such a case, in operation 1i-35, the UE may log the QoE measurement result received in the connection mode as well as the QoE measurement result received in the inactive or idle mode according to the configuration information.

In operation 1i-45, after establishing the RRC connection, the UE may report the availability of the UE's QoE data logging to the base station 1i-05 by using the following messages.
UE assistance information
In addition, existing dedication uplink RRC message
New dedicated message

The availability may include some or all of the following pieces of information.
Whether there is QoE data logged by the UE
Service type of logged QoE data
ID to identify QoE measurement configuration and reporting at an RRC level: It may be indicated which QoE measurement configuration and reporting triggered availability transmission.
Priority of logged QoE data: Data with higher priority may be retrieved by the base station with priority.
Multiple priorities in logged QoE data
Remaining logged data validity time of logged QoE data
Remaining retrieval validity time of logged QoE data
The amount or number of logged QoE data

Availability information may be indicated for logged data in each of the idle mode and the inactive mode. Multiple pieces of availability information (e.g., per service type, per priority, or per QoE data) may be provided. In an embodiment of the disclosure, the availability information may provide an average value for multiple pieces of logged QoE data. In an embodiment of the disclosure, one RRC message may include multiple pieces of availability information.

In order for the UE AS 1i-10 to transmit a message including availability, some or all of the following conditions may need to be satisfied.
When a new base station supports QoE measurements in inactive and/or idle mode.
When QoE data received from the application layer is being logged.
When QoE data that hasn't been reported to the base station is being logged.
When the UE is in a connected mode.
When the size of logged QoE data exceeds a specific threshold (a fixed value defined in logged QoE configuration information or a standard).
When the number of pieces of logged QoE data exceeds a specific threshold (a fixed value included in the logged QoE configuration information or as a fixed value defined in the standard).
When the retrieval validity time is valid or if a related timer is running (a timer having duration defined in the logged QoE configuration information or a timer having fixed duration defined in the standard).

In one embodiment, the configuration information may be triggered for data collected in each of the idle mode and the inactive mode. In an embodiment of the disclosure, the configuration information may be triggered per service type and per priority. In this case, the UE may report only on the triggered data. A prohibit timer may be introduced to prevent too frequent availability reports.

In operation 1i-50, the base station 1i-05, having received the availability information from the UE, may request the UE to retrieve the QoE data. The base station may include retrieval information in a dedicated message, such as the following, and then transmit the message to the UE.
UE information request
RRC reconfiguration
In addition, existing dedication downlink RRC messages
New dedicated RRC message: A new dedicated RRC message for retrieval may be defined.

The base station may include the retrieval request in a broadcast message such as the following, and transmit the message to the UE.
SIB
Multicast control channel (MCCH): This is a channel for transmitting an MBMS service-related control message, and the MCCH may be reused to transmit the retrieval request.

In addition, without operation 1i-45 (when there is no definition in the standard, or when there is a definition in the standard but the UE has not sent the availability), the base station may request a retrieval from the UE. The UE having received the retrieval request may not report when there is no logged data, or may report under predetermined conditions when there is logged data.

Information included in the retrieval request may include some or all of the following.
Indicator indicating whether to retrieve logged QoE data.
Service type: Retrieval may be requested only for a specific service type.
ID to identify QoE measurement configuration and reporting at an RRC level: This may indicate which QoE measurement configuration and reporting triggered the retrieval request.
Logged data validity time: If the time elapsed since the UE AS logged QoE data is within the logged data validity time, the UE may report the QoE data. If the time elapsed since the UE AS logged the QoE data is equal to or longer than a value of the logged data validity time, the UE may have difficulty in reporting the QoE data. This may be because old logged QoE data is unnecessary information for the base station or TCE.
Retrieval validity time: The UE may have to report the QoE report to the base station within the retrieval validity time from the time point at which the UE has received the retrieval request from the base station. After that, reporting may be difficult.
Threshold for QoE data size. The UE may report to the base station only when the logged data size exceeds the threshold. The threshold for QoE data size may also be applied on a per-service-type basis. The UE may report to the base station only when a logged data size for one service type exceeds a threshold for the service type.
Threshold for the number of pieces of QoE data. The UE may report to the base station only when the number of pieces of logged data exceeds the threshold. The threshold for the number of pieces of QoE data may, for example, also be applied on a per-service-type basis. That is, the UE may report to the base station only when the number of pieces of logged data for one service type exceeds a threshold for the service type.
QoE data size to retrieve: The QoE data size to retrieve may be designated as the maximum QoE data size that the UE AS can report. If the logged data size is larger than the QoE data size to retrieve, the UE may not transmit all pieces of logged data and may report only some pieces of logged data (e.g., based on at least one of the following: in order of higher QoE data priority; in order of higher service type priority; FIFO; or LIFO).
Number of pieces of QoE data to retrieve: The number of pieces of QoE data to retrieve may be designated as the maximum number of pieces of QoE data that the UE AS can report. If the number of pieces of logged data is greater than the number of pieces of QoE data to retrieve, the UE may not transmit all pieces of logged data and may report only some pieces of logged data (according to at least one of the following: in order of higher QoE data priority, in order of higher service type priority, FIFO, or LIFO).

In an embodiment, the above-described configuration information may be indicated for each of QoE data stored in the idle mode and QoE data stored in the inactive mode. In an embodiment, multiple pieces of configuration information may be designated (e.g., per service type or per priority). In an embodiment of the disclosure, one RRC message may include multiple pieces of retrieval request information.

In operation 1i-55, the UE having received the retrieval may report the logged QoE data to the base station 1i-05. To report the QoE data, the following messages may be used.
MeasurementReportAppLayer message: A MeasurementReportAppLayer used to report QoE measurement in a connected mode may be reused. When the UE transmits a MeasurementReportAppLayer to report measured QoE in a connected mode, the UE may also report a logged QoE measurement value, if any. The QoE measurement report in the connected mode and the QoE measurement report in an inactive and/or idle mode may be distinguished within the MeasurementReportAppLayer. The QoE measurement report in the inactive and/or idle mode may be performed independently or separately in accordance with this disclosure, rather than together with the QoE measurement report in the connected mode, even when the MeasurementReportAppLayer message is reused. The MeasurementReportAppLayer message may be transmitted to SRB4. Hereafter, MeasurementReportAppLayer can be used interchangeably with MeasurementReportAppLayer message.
RRC reconfiguration complete message: When the base station requests retrieval through an RRC reconfiguration message, the UE may report a QoE measurement result through an RRC reconfiguration complete message.
UE information response: When the base station requests retrieval through a UE information request message, the UE may report a QoE measurement result through a UE information response message.
UE assistance information: The base station may configure a prohibit timer to prevent the UE from indiscriminately reporting QoE measurement results.
In addition, existing dedication uplink RRC message
New dedicated message: For example, a message such as MeasLoggedReportApplayer may be defined.

The QoE measurement result report may include some or all of the following pieces of information.
Container for reporting QoE data from the application layer to the base station (e.g., MeasurementReportAppLayerContainer)
Service type of the reported QoE data
ID to identify QoE configuration at an RRC level: This may indicate which QoE measurement configuration information has been used to generate a QoE measurement result report.
Indicator indicating whether there is any additional logged data (or data for additional reporting) in addition to the report.
Absolute time information of data logging: Time information may be used to correlate an MDT measurement result with a QoE measurement result.
Relative time information of data logging: Information that indicates how much more time has passed since at a time point when the UE logged data based on absolute time (the absolute time of a cell at a time point of providing configuration information) information received through logged QoE configuration information.
Absolute time information of data reporting: Time information may be used to correlate an MDT measurement result and a QoE measurement result.
Relative time information of data reporting: Information that indicates how much more time has passed since at a time point when the UE reported data based on absolute time (the absolute time of a cell at a time point of providing configuration information) information received through logged QoE configuration information.
Priority of QoE data (for example, information provided by the application layer): This indicates the priority of data to be reported.
Trace reference information
Trace recording session reference information
The base station may transmit QoE data information reported by the UE to a data server designated by a TCE ID.

In an embodiment of the disclosure, multiple pieces of QoE measurement report information may be included (e.g., per QoE data or per service type). In an embodiment of the disclosure, the QoE measurement report information may be indicated for data logged in each of an idle mode and an inactive mode. In an embodiment of the disclosure, one RRC message may include multiple pieces of QoE measurement report information.

In order to report the QoE measurement result including the above-described information to the base station 1i-05, the UE may use some or all of the following conditions.
When the UE has received a retrieval request from the base station
When the UE is storing the QoE measurement result (for example, QoE data)
When the UE is in a connected mode
When the size of logged QoE data exceeds a specific threshold (for example, as fixed value defined in logged QoE configuration information or in a standard)
When the number of pieces of logged QoE data exceeds a specific threshold (for example, a value included in the logged QoE configuration information or a fixed value defined in the standard)
When the retrieval validity time is valid or when a related timer is running (a timer having duration configured in the logged QoE configuration information or a timer having fixed duration defined in the standard)
When the report validity time is valid or when a related timer is running (a timer having duration configured in the logged QoE configuration information or a timer having fixed duration defined in the standard)
When specific conditions defined in the logged QoE configuration information or the retrieval message are satisfied
When specific conditions defined in the standard are satisfied

The UE may start reporting the QoE measurement result even when there is no retrieval request from the base station. When the UE has started reporting the QoE measurement result, and when the UE in the inactive and/or idle mode determines to report the QoE measurement result by using the above-described conditions, the UE may request an RRC connection via at least one of an RRC setup request, an RRC resume request, or an RRC reestablishment request while specifying the cause for the connection request as being for QoE measurement. In an embodiment, the base station having received the above-described cause may know that the UE wants to establish an RRC connection for reporting the QoE measurement result, and may establish the RRC connection by configuring necessary SRB (e.g., SRB4) for the UE through the above-described cause.

Then, the UE may report the QoE measurement result through at least one of RRC setup complete, RRC resume complete, or RRC reestablishment complete. In an embodiment, after completing the connection, the UE may use the above-described other messages for reporting. In an embodiment, after the UE completes the connection, the base station may transmit a retrieval request, and the UE may report in response to the retrieval request.

The UE may use both a method for triggering a report without retrieval from the base station and a method for triggering a report with retrieval received from the base station.

Previously, reporting of logged MDTs may be done using SRB2, but reporting of QoE measurement in a connected mode (e.g., reporting of QoE measurement in an LTE system) may be done using SRB4 (e.g., the lowest-priority SRB). According to an embodiment of the disclosure, the UE may use SRB4 as before to report QoE measurement in a connected mode, while SRB2 may be used to report QoE measurement in an inactive and/or idle mode. In one embodiment of the disclosure, reporting of QoE measurement in at least one of the connected mode, the inactive mode, or the idle mode may all be done using SRB4. In an embodiment of the disclosure, reporting of QoE measurement in at least one of the connected mode, the inactive mode, or the idle mode may all be done using SRB2.

The UE that is performing at least one of QoE measurement, logging, or reporting in an inactive and/or idle mode may camp on a new base station via mobility. At this time, the UE may determine logging or reporting based on previously received logged QoE configuration information or logged QoE configuration information transmitted by the new base station (e.g., at least one of Area Configuration, plmn-IdentityList, or indicator indicating whether to directly measure/store/report QoE). In an embodiment of the disclosure, the UE may report availability to the new base station and wait for a response (e.g., at least one of retrieval or new logged QoE configuration) from the base station, and may respond (e.g., determine whether to report) based on the base station's response.

In an embodiment, when the RRC mode transitions, the UE may reuse some (or all) pieces of pre-transition QoE configuration information even after the transition. In an embodiment of the disclosure, the base station may transmit new configuration information to the UE. This may not apply when the UE that does not retain previous configuration information performs RRC mode transition (e.g., at least one of the transition from a connected mode to an idle mode or the transition from the idle mode to the connected mode). In an embodiment, when the base station transmits the new configuration information to the UE (e.g., in the case unrelated to a change in RRC mode), transmission of only some changed pieces of configuration information (delta signaling) may be more efficient in using limited radio resources than transmission of all pieces of the configuration information. When the base station provides only some changed pieces of the configuration information, the UE may keep the configuration information that has not been provided, and may update and use only the newly configured information.

In an embodiment, all or some of fields and messages of at least one of configuration (e.g., LoggedMeasurementConfiguration), report (e.g., LogMeasReport), or UE variable (e.g., VarLogMeasConfig/VarLogMeasReport) that are used for existing logged MDT measurements may be shared for logged QoE measurement. In an embodiment of the disclosure, messages or information for logged QoE measurement may be defined, used, and/or stored separately from or independently of the existing logged MDT measurements.

In an LTE system, when the UE AS receives a measurement result in a connected mode from the application layer, the UE AS may report the measurement result to the base station in the connected mode without a separate logging procedure. On the other hand, according to an embodiment of the disclosure, the UE AS may use a unified framework regardless of the RRC mode by logging the measurement result in the connected mode. Even in the connected mode, the UE may log the measurement result first and then report the measurement result to the base station. In this case, the UE may equally use some or all of the logged QoE measurement configuration regardless of the RRC mode, and the base station may not need to transmit, to the UE, a separate configuration message (e.g., measConfigAppLayer) for only the RRC connection mode. Not all configuration information may be uniformly applied to all RRC modes. Mode-specific information may be provided within a single configuration message. In addition, in the context of the existing LTE technology, a procedure for logging an MBS single frequency network (MBSFN) measurement result regardless of the idle mode and/or connected mode may be defined as follows.
1> if not suspended, perform the logging in accordance with the following:
2> if targetMBSFN-AreaList is included in VarLogMeasConfig:
3> if the UE is camping normally on an E-UTRA cell or is connected to E-UTRA; and
3> if the RPLMN is included in plmn-IdentityList stored in VarLogMeasReport; and
3> if the PCell (in RRC_CONNECTED) or cell where the UE is camping (in RRC_IDLE) is part of the area indicated by areaConfiguration if configured in VarLogMeasConfig:
4> for MBSFN areas, indicated in targetMBSFN-AreaList, from which the UE is receiving MBMS service:
5> perform MBSFN measurements in accordance with the performance requirements as specified in TS 36.133 [16];
NOTE 1: When configured to perform MBSFN measurement logging by targetMBSFN-AreaList, the UE is not required to receive additional MBSFN subframes, i.e. logging is based on the subframes corresponding to the MBMS services the UE is receiving.
5> perform logging at regular time intervals as defined by the loggingInterval in VarLogMeasConfig, but only for those intervals for which MBSFN measurement results are available as specified in TS 36.133 [16];
In an NR system, it may be considered to reuse or enhance some or all of the above-described procedures to log a QoE measurement result regardless of the RRC mode.

The following agreement was reached at the 3GPP RAN2 working group standard meeting (RAN2 #119bis-e).

For buffering of QoE reports generated in RRC IDLE/INACTIVE state, RAN2 should discuss at least the minimal memory size requirement. FFS if AS layer is responsible for storing the QoE reports (as in Rel-17).

According to FIG. 1I, the UE may perform QoE measurement in an inactive (RRC_INACTIVE) or idle mode (RRC_IDLE), and may store the measurement result for future reporting (1i-35).

In one embodiment of the disclosure, the UE application layer (APP) may store the result of the QoE measurement performed in the idle mode or the inactive mode in a memory of the UE AS layer. The memory of the UE AS layer may be limited. In an embodiment of the disclosure, the UE may share and/or use the AS layer memory, which is used to store a QoE measurement report when paused (e.g., when pauseReporting is configured to be true), to store a QoE measurement report obtained in the idle mode and/or the inactive mode. In an embodiment of the disclosure, the UE may define and use a separate AS layer memory for storing only a QoE measurement report obtained in the idle mode and/or the inactive mode. The UE application layer (APP) may transmit a QoE measurement result to the UE AS layer periodically or whenever the QoE measurement result is generated based on the received QoE configuration information. Since the UE is in the idle or inactive mode, the QoE measurement result may not be reported to the base station and may be stored in the AS layer's memory. When the memory is full, the UE AS may transmit indicator 1 to the UE APP in order to notify the UE APP that the memory is full or instruct the UE APP to stop QoE measurement. Indicator 1 may be defined as a parameter in an AT command. When indicator 1 is present or configured to be true, indicator 1 may signify that the UE AS is informing the UE APP that memory is full or instructing the UE APP to stop the QoE measurement. When indicator 1 is present or configured to be true, the UE APP that has received indicator 1 may stop the QoE measurement and stop reporting of the QoE measurement to the UE AS. Subsequently, when the UE AS memory has free space (e.g., when a stored QoE measurement report is discarded after reporting to the base station, or when a stored QoE measurement report expires and is discarded), the UE AS may transmit indicator 1 to the UE APP to indicate that the memory is empty (or free) or to instruct the UE APP to resume QoE measurement. When indicator 1 is absent or configured to be false, indicator 1 may signify that the UE AS is informing the UE APP that memory is not full (or that there is free space for storage), or instructing the UE APP to resume QoE measurement. When indicator 1 is absent or configured to be false, the UE APP that has received indicator 1 may resume QoE measurement and resume reporting of the QoE measurement to the UE AS.

In an embodiment of the disclosure, even when the memory is full, the UE AS layer may not notify this to the APP, and the APP may continue to perform a QoE measurement report and transmit the QoE measurement report to the AS layer. When the UE As receives the QoE measurement report while the memory is full, the UE AS may discard the oldest data stored in the memory and store (overwrite) measurement result data newly received from the APP in the memory space. This is because the latest QoE measurement result may be more useful information for network operation. In an embodiment, the UE AS with a full memory may immediately discard the QoE measurement result newly received from the APP without storing the QoE measurement result in the memory.

In an embodiment, the UE with multiple QoE configurations (e.g., distinguished and/or indicated by respective configuration measConfigAppLayerIds) may have a priority for AS memory storage defined for each configuration (e.g., each measConfigAppLayerId). The priority for each measConfigAppLayerId may be configured by the OAM and transmitted to the UE AS via the OAM, the CN, and the base station (e.g., operations 1f-30, 1f-35, and 1f-40 or corresponding operations in 1G). The priority for each measConfigAppLayerId may be included in the QoE configuration information and transmitted in operations 1f-30, 1f-35, 1f-40, or corresponding operations in 1G. As a result, when the memory is full, and when the QoE measurement result newly received from the APP (e.g., a measurement result for measConfigAppLayerId=2) has a priority higher than (or higher than or equal to) the priority of (some of) existing QoE measurement results (e.g., a measurement result for measConfigAppLayerId=1) stored in the memory, the UE AS may delete the lower-priority existing QoE measurement results from the memory and overwrite the existing QoE measurement results with the new measurement result. Otherwise (e.g., when the QoE measurement result newly received from the APP has a priority lower than (or lower than or equal to) the priority of (all) existing QoE measurement results stored in the memory), the UE AS may discard the QoE measurement result newly received from the APP without storing the QoE measurement.

When the memory is full, the UE AS layer may establish an RRC connection with the base station in order to transmit the stored QoE measurement report. For example, the UE in the idle mode may request the establishment of an RRC connection by sending an RRC Setup request to the base station. When the memory is full, the UE in the inactive mode may request the establishment of an RRC connection by sending an RRC resume request to the base station. The UE may transmit the QoE measurement report stored in memory (e.g., after going through operations 1i-45 and 1i-50) to the base station. In order to indicate whether the base station should allow the above-described operation of the UE (e.g., the operation in which when the memory is full, the UE AS layer makes a request to the base station for an RRC connection in order to transmit the stored QoE measurement report), an indicator A may be defined within the QoE configuration (e.g., 1i-25). When the base station includes the indicator A in the QoE configuration or configures the indicator A to be true, the UE may perform the above-described operation of the UE (e.g., the operation in which when the memory is full, the UE AS layer makes request to the base station for RRC connection in order to transmit the stored QoE measurement report). Conversely, when the base station does not include the indicator A in the QoE configuration or configures the indicator A to be false, the UE may not perform the above-described operation of the UE (e.g., the operation in which when the memory is full, the UE AS layer makes a request to the base station for an RRC connection in order to transmit the stored QoE measurement report). Before the base station configures the indicator A, the UE may report to the base station whether the UE supports the above-described operation of the UE (e.g., the operation in which when the memory is full, the UE AS layer makes a request to the base station for an RRC connection in order to transmit the stored QoE measurement report) (e.g., 1i-20). In order for the UE to report to the base station whether the UE supports the above-described operation of the UE (e.g., the operation in which when the memory is full, the UE AS layer makes a request to the base station for an RRC connection in order to transmit the stored QoE measurement report), an indicator B may be defined within a UE capability message indicating whether the UE supports the above-described operation of the UE. When the UE includes the indicator B in the UE capability message or configures the indicator B to be true, it may signify that the UE supports the above-described operation of the UE (e.g., the operation in which when the memory is full, the UE AS layer makes a request to the base station for an RRC connection in order to transmit the stored QoE measurement report), and based on indicator B, the base station may allow the above-described operation of the UE (e.g., by including the indicator A in the QoE configuration or configuring the indicator A to be true). Conversely, when the UE does not include the indicator B within the UE capability message or configures the indicator to be false, it may signify that the UE does not support the above-described operation of the UE (e.g., the operation in which when the memory is full, the UE AS layer makes a request to the base station for an RRC connection in order to transmit the stored QoE measurement report), and based on the indicator B, the base station may not allow the above-described operation of the UE (e.g., by not including the indicator A within QoE configuration or by configuring the indicator A to be false).

In one embodiment of the disclosure, the UE APP may store the result of QoE measurement result performed in the idle or inactive mode in the UE APP layer. The UE APP may store the result of the performed QoE measurement in the memory of the APP layer without immediately or periodically sending the results to the AS layer. The memory of the UE APP layer may be limited. Due to continuous QoE measurement, the memory of the UE APP that stores the measurement result may become full. When the memory is full, the UE APP may not store an additional measurement result and may thus stop QoE measurement. Later, when the memory has free space again (e.g., when sending a QoE measurement report to the AS layer and delete the data, or when discarding a QoE measurement report that has expired), the UE APP may resume QoE measurement.

In an embodiment of the disclosure, when the memory is full, the UE APP may discard the oldest data stored in the memory and store (overwrite) newly measured data in the memory space. This is because the latest QoE measurement result may be more useful information for network operation. In an embodiment of the disclosure, the UE APP with a full memory may immediately discard the newly measured QoE result without storing the newly measured QoE result in the memory.

In an embodiment of the disclosure, the UE with multiple QoE configurations (e.g., distinguished and/or indicated by respective configuration measConfigAppLayerIds) may have a priority for APP memory storage defined for each configuration (e.g., each measConfigAppLayerId). The priority for each measConfigAppLayerId may be configured by the OAM and transmitted to the UE APP via the OAM, the CN, the base station, and the UE AS (e.g., at least one among operations 1f-30, 1f-35, 1f-40, and 1f-50 or corresponding operations in 1G). The priority for each measConfigAppLayerId may be included in the QoE configuration information and transmitted in at least one among operations 1f-30, 1f-35, 1f-40, and 1f-50 or corresponding operations in 1G. Therefore, when the memory is full, and when the newly obtained QoE measurement result (e.g., the measurement result for measConfigAppLayerId=2) has a priority higher than (or higher than or equal to) the priority of (some of) existing QoE measurement results (e.g., a measurement result for measConfigAppLayerId=1) stored in the memory, the UE APP may delete the lower-priority existing QoE measurement results from the memory and overwrite the existing QoE measurement results with the new measurement result. Otherwise (e.g., when the newly obtained QoE measurement result has a priority lower than (or lower than or equal to) the priority of (all) existing QoE measurement results stored in the memory), the UE AS may discard the newly obtained QoE measurement result without storing the QoE measurement.

In one embodiment of the disclosure, when the UE APP stores a QoE measurement report, the UE AS may make a request to the UE APP (e.g., via indicator 2 in an AT command) for indication of whether there is a stored QoE measurement report in order to determine whether the UE transitions to a connected mode, or transmit or indicate an availability indicator (e.g., 1i-40 or 1i-45). The UE APP having received the request may transmit, to the AS, indication of whether there is a stored QoE measurement report (e.g., through indicator 3 in the AT command). When the AS receives indication that there is a stored QoE measurement report from the APP (e.g., when indicator 3 is included in the AT command or configured to be true), the UE AS may transition to the connected mode, or may transmit an availability indicator to the base station when transitioning to the connected mode. When the AS receives the indication that there is no stored QoE measurement report from the APP (e.g., when indicator 3 is omitted in the AT command or configured to be false), the UE AS may not transition to the connected mode, or may not send an availability indicator to the base station when transitioning to the connected mode.

The following operation may be defined such that the UE APP may notify the AS layer whether there is a stored QoE measurement report (e.g., without a request from the AS or without indicator 2). When a new QoE measurement result is stored for the first time while the memory is empty, the UE APP may notify the UE AS of the new QoE measurement result (e.g., through indicator 4 in the AT command). For example, when indicator 4 is included in the AT command or configured to be true, the indicator 4 may indicate that the QoE measurement result is stored in the memory of the UE APP. Conversely, when the memory is empty because all pieces of data in the memory have disappeared (e.g., has been discarded or cleared by a successful transfer), the UE APP may notify the UE AS that the memory is empty because all pieces of data in the memory has disappeared (e.g., through indicator 4 in the AT command). For example, when indicator 4 is omitted in the AT command or configured to be false, it may be indicated that the UE APP's memory is empty.

In one embodiment of the disclosure, when a UE APP stores a QoE measurement report, and when the UE receives a retrieval request (e.g., 1i-50) from the base station in a connected mode, the UE AS may transmit the retrieval request to the APP (e.g., through an AT command), and some or all pieces of the configuration information included in 1i-50 may be used for the transmission of the QoE measurement report of the UE APP. The UE APP that has received the retrieval request via the AT command may transmit the stored measurement report to the UE AS (e.g., based on the configuration information in the received retrieval request). The UE APP may discard, from its memory, the QoE measurement result transmitted to the UE AS.

In an embodiment of the disclosure, the UE may report a QoE result measured in the idle mode or inactive mode for one piece of QoE measurement configuration information to the base station via the processes in FIG. 1I (e.g., at least one of the logging, availability, or retrieval request process). On the other hand, even in a connected mode, the UE may use the same QoE measurement configuration information to perform QoE measurement. The UE APP may not be aware of the RRC state of the AS layer, and may perform QoE measurement based on the same QoE measurement configuration information regardless of the RRC state. The UE may also report the QoE measurement result obtained in the connected mode to the base station via the processes in FIG. 1I (at least one of the logging, availability, or retrieval request process). That is, the UE may report the measurement result to the base station via the logging, availability, or retrieval request process without immediately reporting the measurement result even when the UE is in the connected mode, and may report the measurement result in the inactive and/or idle mode together. Thus, there may be the advantage in that the UE may perform the same operation (e.g., FIG. 1I) regardless of the RRC state.

In an embodiment of the disclosure, the UE may immediately report the QoE measurement result obtained in the connected mode to the base station without following the processes in FIG. 1I (at least one of the logging, availability, or retrieval request process). Thus, there may be the advantage in that the UE may report the QoE measurement result to the base station quickly without delay in the connected mode. However, when the UE fails to send a QoE measurement result in the connected mode (e.g., just before sending) and the UE transitions to the idle or inactive mode, the QoE measurement result may be stored (e.g., stored using the memory for storing a QoE measurement result in the inactive or idle mode). In addition, when the UE transitions to the idle mode (or the inactive mode), the QoE configuration may be stored without being deleted. In the idle mode (or the inactive mode), the UE may perform QoE measurement by using the same QoE configuration as in the connected mode, and may store the measurement result in the memory. That is, the UE may have a QoE measurement result which was stored but not sent in the connected mode, and/or a QoE measurement result obtained in the inactive and/or idle mode. Then, when the UE transitions back to the connected mode and reports the QoE measurement result in the inactive and/or idle mode to the base station according to the processes in FIG. 1I, the UE may transmit the QoE measurement result that was stored but not sent in the connected mode.

In one embodiment of the disclosure, when the UE in the idle or inactive mode performs QoE measurement in operation 1i-35 and receives an RRC setup from the new base station in operation 1i-40 (e.g., in the case of the UE in the inactive mode, when the base station failed in inactive context retrieval), the UE AS may release the QoE configuration. This is because the new base station may not be aware of the QoE configuration that was set for the UE. The UE AS may release the QoE configuration while instructing the UE APP to release a corresponding QoE configuration and stop the measurement. However, the UE may report the QoE measurement result obtained and stored in idle or inactive mode to the base station. In this case, the UE APP and/or the UE AS may include the address of an MCE or TCE server in the measurement report to the base station so that the base station without information about the corresponding QoE configuration can transmit the corresponding QoE measurement result to the correct MCE or TCE server. In order for the UE APP and/or the UE AS to include the address of the MCE or TCE server in the measurement report to the base station, the UE may need to have the corresponding information configured and stored in advance (e.g., an MCE or TCE ID may be included in 1i-25 and transmitted, and the UE may be storing the MCE or TCE ID).

In an embodiment, the UE APP and/or the UE AS may include a QoE reference ID in a measurement report to the base station, and the base station having received the measurement report may locate a correct MCE/TCE server based on the QoE reference ID (e.g., through coordination with an AMF) and transmit the measurement result to that server. In order for the UE APP and/or the UE AS to include the QoE reference ID in the measurement reporting to the base station, the UE may need to have the corresponding information configured and stored in advance (e.g., the QoE reference ID may be included in 1i-25 and transmitted, and the UE may be storing the QoE reference ID).

In an embodiment of the disclosure, depending on an area configuration included in 1i-25, the UE may perform logged QoE measurement in a corresponding area in an idle or inactive mode and may log the measurement result. When the UE leaves the configured area (e.g., at least one of when camping on a cell outside the configured area, when performing reselection, or when performing inter-RAT cell reselection), the UE may release the set QoE configuration and discard measurement results obtained during that time. This is because a base station outside the configured area may not support an MBS service, or may not support a QoE measurement report even when an RRC connection with the base station is reestablished.

In an embodiment of the disclosure, when the UE leaves the configured area (e.g., at least one of when camping on a cell outside the configured area, when performing reselection, or when performing inter-RAT cell reselection), the UE may temporarily suspend QoE measurement and/or reporting without releasing (e.g., while storing) the QoE configuration and without discarding (e.g., while continuing to store) the stored QoE measurement result. Subsequently, when the UE reenters the configured area, the UE may resume measurement based on the QoE configuration and perform a QoE measurement report.

FIG. 1Y illustrates the inner structure of a UE according to an embodiment of the disclosure.

Referring to FIG. 1Y, the UE may include a radio frequency (RF) processor 1y-10, a baseband processor 1y-20), a storage unit 1y-30, and a controller 1y-40.

The RF processor 1y-10 may perform functions, such as signal band conversion and signal amplification, for transmitting and/or receiving a signal via a wireless channel. The RF processor 1y-10 may up-convert a baseband signal provided from the baseband processor 1y-20 into an RF band signal and then transmit the RF band signal via an antenna, and may down-convert an RF band signal received via the antenna into a baseband signal. In an example, the RF processor 1y-10 may include a transmission filter, a reception filter, an amplifier, a mixer, an oscillator, a digital-to-analog converter (DAC), an analog-to-digital converter (ADC), etc. In the drawing, only one antenna is shown, but the UE may have multiple antennas. In addition, the RF processor 1y-10 may include multiple RF chains. The RF processor 1y-10 may perform beamforming. For beamforming, the RF processor 1y-10 may adjust the phase and magnitude of each of signals transmitted and/or received through the multiple antennas or antenna elements. The RF processor may also perform multiple-input and multiple-output (MIMO), and may receive multiple layers when performing the MIMO operation.

The baseband processor 1y-20 may perform a function of conversion between baseband signals and bitstreams in accordance with the physical layer specifications of a system. In an example, when transmitting data, the baseband processor 1y-20 may generate complex symbols by encoding and modulating a transmitted bitstream. Furthermore, when receiving data, the baseband processor 1y-20 may restore a received bitstream by demodulating and decoding a baseband signal provided from the RF processor 1y-10. In another example, in accordance with orthogonal frequency division multiplexing (OFDM), when transmitting data, the baseband processor 1y-20 may generate complex symbols by encoding and modulating a transmitted bitstream, and may construct OFDM symbols by mapping the complex symbols to subcarriers and then performing an inverse fast Fourier transform (IFFT) operation and cyclic prefix (CP) insertion. Additionally, when receiving data, the baseband processor 1y-20 may divide a baseband signal provided by the RF processor 1y-10 into OFDM symbol units, and may restore a received bitstream by restoring signals mapped to subcarriers through a fast Fourier transform (FFT) operation and then demodulating and decoding the restored signals.

The baseband processor 1y-20 and the RF processor 1y-10 may transmit and receive signals as described above. Accordingly, the baseband processor 1y-20 and the RF processor 1y-10 may be referred to as a transmitter, a receiver, a transmission and/or reception unit, or a communication unit. At least one of the baseband processor 1y-20 and the RF processor 1y-10 may include multiple communication modules to support multiple different wireless access technologies. Furthermore, at least one of the baseband processor 1y-20 and the RF processor 1y-10 may include different communication modules to process signals in different frequency bands. For example, the different wireless access technologies may include wireless LAN (e.g., IEEE 802.11), cellular networks (e.g., LTE), etc. In addition, the different frequency bands may include a super high frequency (SHF) band (e.g., 2.NRHz or NRhz) and millimeter wave (mmWave) bands (e.g., 60 GHz).

The storage unit 1y-30 may store data such as basic programs, applications, configuration information, etc. for operation of the UE. The storage unit 1y-30 may store information related to a second access node that performs wireless communication by using a second wireless access technology. The storage unit 1y-30 may provide stored data in response to a request from the controller 1y-40.

The controller 1y-40 may control the overall operations of the UE. For example, the controller 1y-40 may transmit and/or receive signals through the baseband processor 1y-20 and the RF processor 1y-10. The controller 1y-40 may write and read data to and from the storage unit 1y-30. To this end, the controller 1y-40 may include at least one processor. For example, the controller 1y-40 may include a communication processor (CP) for controlling communication and an application processor (AP) for controlling a higher layer such as an application. In addition, the controller 1y-40 may include a multi-connection processor 1y-42 configured to handle a process operating in multiple connection mode. In addition, at least one component of the terminal may be implemented as one chip.

FIG. 1Z illustrates the configuration of a base station according to an embodiment of the disclosure.

Referring to FIG. 1Z, the base station may include an RF processor 1z-10, a baseband processor 1z-20, a backhaul communication unit 1z-30, a storage unit 1z-40, and a controller 1z-50.

The RF processor 1z-10 may perform functions, such as signal band conversion and signal amplification, for transmitting and/or receiving signals via a wireless channel. The RF processor 1z-10 may up-convert a baseband signal provided by the baseband processor 1z-20 into an RF band signal and then transmit the RF band signal via an antenna, and may down-convert an RF band signal received via the antenna into a baseband signal. For example, the RF processor 1z-10 may include a transmission filter, a reception filter, an amplifier, a mixer, an oscillator, a DAC, an ADC, etc. In the drawing, only one antenna is shown, but a first access node may include multiple antennas. Additionally, the RF processor 1z-10 may include multiple RF chains. The RF processor 1z-10 may perform beamforming. For beamforming, the RF processor 1z-10 may adjust the phase and magnitude of each of signals transmitted and/or received through the multiple antennas or antenna elements. The RF processor may perform a downlink MIMO operation by transmitting one or more layers.

The baseband processor 1z-20 may perform a function of conversion between baseband signals and bitstreams in accordance with the physical layer specifications of a first wireless access technology. For example, when transmitting data, the baseband processor 1z-20 may generate complex symbols by encoding and modulating a transmitted bitstream. Additionally, when receiving data, the baseband processor 1z-20 may restore a received bitstream by demodulating and decoding a baseband signal provided from the RF processor 1z-10. For example, in accordance with OFDM, when transmitting data, the baseband processor 1z-20 may generate complex symbols by encoding and modulating a transmitted bitstream, and may construct OFDM symbols by mapping the complex symbols to subcarriers and then performing an IFFT operation and CP insertion. In addition, when receiving data, the baseband processor 1z-20 may divide a baseband signal provided by the RF processor 1z-10 into OFDM symbol units, and may restore a received bitstream by restoring signals mapped to subcarriers through an FFT operation and then demodulating and decoding the restored signals. The baseband processor 1z-20 and the RF processor 1z-10 may transmit and receive signals as described above. Accordingly, the baseband processor 1z-20 and the RF processor 1z-10 may be referred to as a transmitter, a receiver, a transmission and/or reception unit, a communication unit, or a wireless communication unit.

The backhaul communication unit 1z-30 may provide an interface for performing communication with other nodes in a network. The backhaul communication unit 1z-30 may convert bitstreams transmitted from a main base station to other nodes, for example, a secondary base station and a core network, into physical signals, and may convert physical signals received from other nodes into bitstreams.

The storage unit 1z-40 may, for example, store data such as basic programs, applications, configuration information, etc. for operation of the main base station. In particular, the storage unit 1z-40 may store information about a bearer assigned to a connected UE, a measurement result reported from the connected UE, etc. In addition, the storage unit 1z-40 may store information that serves as criteria for determining whether to provide or discontinue multi-connection to the UE. The storage unit 1z-40 may provide the stored data in response to a request from the controller 1z-50.

The controller 1z-50 may, for example, control the overall operations of the main base station. For example, the controller 1z-50 may transmit and/or receive signals through the baseband processor 1z-20 and the RF processor 1z-10 or through the backhaul communication unit 1z-30. Furthermore, the controller 1z-50 may write and read data to and from the storage unit 1z-40. To this end, the controller 1z-50 may include at least one processor. In addition, the controller 1z-50 may include a multi-connection processor 1z-52 configured to handle a process operating in multiple connection mode. In addition, at least one component of the base station may be implemented as one chip.

In an embodiment, a method performed by a user equipment (UE) in a wireless communication system, the method comprising: receiving, from a base station, configuration information for a quality of experience (QoE) measurement; storing a result of the QoE measurement performed in a radio resource control (RRC) idle state or an RRC inactive state in an access stratum (AS) layer memory of the UE; and transmitting, to the base station, a QoE report including the result of the QoE measurement based on the configuration information.

In an embodiment, wherein the AS layer memory is shared with a memory for a QoE paused measurement report or is additional to the memory for the QoE paused measurement report.

In another embodiment, wherein, in case that the AS layer memory is full, at least one QoE report is discarded based on a storage order or a priority.

In yet another embodiment, wherein the QoE report is transmitted to the base station in an RRC connected state.

In still another embodiment, wherein the QoE report is for multicast and broadcast services (MBS) broadcast.

In an embodiment of the disclosure, a method performed by a base station in a wireless communication system, the method comprising: transmitting, to a user equipment (UE), configuration information for a quality of experience (QoE) measurement; and receiving, from the UE, a QoE report including a result of the QoE measurement based on the configuration information, wherein the result of the QoE measurement performed in a radio resource control (RRC) idle state or an RRC inactive state is stored in an access stratum (AS) layer memory of the UE.

In one embodiment, wherein the AS layer memory is shared with a memory for a QoE paused measurement report or is additional to the memory for the QoE paused measurement report.

In another embodiment, wherein, in case that the AS layer memory is full, at least one QoE report is discarded based on a storage order or a priority.

In yet another embodiment, wherein the QoE report is received from the UE in an RRC connected state.

In still another embodiment, wherein the QoE report is for multicast and broadcast services (MBS) broadcast.

In one embodiment, a user equipment (UE) in a wireless communication system, the UE comprising: a transceiver; and at least one processor coupled with the transceiver and configured to: receive, from a base station, configuration information for a quality of experience (QoE) measurement; store a result of the QoE measurement performed in a radio resource control (RRC) idle state or an RRC inactive state in an access stratum (AS) layer memory of the UE; and transmit, to the base station, a QoE report including the result of the QoE measurement based on the configuration information.

In another embodiment, wherein the AS layer memory is shared with a memory for a QoE paused measurement report or is additional to the memory for the QoE paused measurement report.

In still another embodiment, wherein, in case that the AS layer memory is full, at least one QoE report is discarded based on a storage order or a priority.

In an embodiment, wherein the QoE report is transmitted to the base station in an RRC connected state.

In another embodiment, wherein the configuration information is for the QoE measurement of the UE in the idle or the inactive, and wherein the QoE report is for multicast and broadcast services (MBS) broadcast.

In an embodiment, a base station in a wireless communication system, the base station comprising: a transceiver; and at least one processor coupled with the transceiver and configured to: transmit, to a user equipment (UE), configuration information for a quality of experience (QoE) measurement; and receive, from the UE, a QoE report including a result of the QoE measurement based on the configuration information, wherein the result of the QoE measurement performed in a radio resource control (RRC) idle state or an RRC inactive state is stored in an access stratum (AS) layer memory of the UE.

In an embodiment, wherein the AS layer memory is shared with a memory for a QoE paused measurement report or is additional to the memory for the QoE paused measurement report.

In another embodiment, wherein, in case that the AS layer memory is full, at least one QoE report is discarded based on a storage order or a priority.

In still another embodiment, wherein the QoE report is received from the UE in an RRC connected state.

In yet another embodiment, wherein the QoE report is for multicast and broadcast services (MBS) broadcast.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

The program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

While the specific embodiment has been described in the explanations of the disclosure, it will be noted that various changes may be made therein without departing from the scope of the disclosure. Therefore, the scope of the disclosure is not limited and defined by the described embodiment and is defined not only the scope of the claims as below but also their equivalents.

The embodiments described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. In an example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been presented based on the frequency division duplex long term evolution (FDD LTE) system, other variants based on the technical idea of the above embodiments may also be implemented in other systems such as TDD LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirt and scope of the disclosure as defined by the appended claims and their equivalents.

What is claimed is:

1. A method performed by a user equipment (UE) in a wireless communication system, the method comprising:
receiving, from a base station, configuration information for a quality of experience (QoE) measurement;
storing a result of the QoE measurement performed in a radio resource control (RRC) idle state or an RRC inactive state in an access stratum (AS) layer memory of the UE; and
transmitting, to the base station, a QoE report including the result of the QoE measurement based on the configuration information.

2. The method of claim 1, wherein the AS layer memory is shared with a memory for a QoE paused measurement report or is additional to the memory for the QoE paused measurement report.

3. The method of claim 1, wherein, in case that the AS layer memory is full, at least one QoE report is discarded based on a storage order or a priority.

4. The method of claim 1, wherein the QoE report is transmitted to the base station in an RRC connected state.

5. The method of claim 1, wherein the QoE report is for multicast and broadcast services (MBS) broadcast.

6. A method performed by a base station in a wireless communication system, the method comprising:
transmitting, to a user equipment (UE), configuration information for a quality of experience (QoE) measurement; and
receiving, from the UE, a QoE report including a result of the QoE measurement based on the configuration information,
wherein the result of the QoE measurement performed in a radio resource control (RRC) idle state or an RRC inactive state is stored in an access stratum (AS) layer memory of the UE.

7. The method of claim 6, wherein the AS layer memory is shared with a memory for a QoE paused measurement report or is additional to the memory for the QoE paused measurement report.

8. The method of claim 6, wherein, in case that the AS layer memory is full, at least one QoE report is discarded based on a storage order or a priority.

9. The method of claim 6, wherein the QoE report is received from the UE in an RRC connected state.

10. The method of claim 6, wherein the QoE report is for multicast and broadcast services (MBS) broadcast.

11. A user equipment (UE) in a wireless communication system, the UE comprising:
a transceiver; and
at least one processor coupled with the transceiver and configured to:
receive, from a base station, configuration information for a quality of experience (QoE) measurement,
store a result of the QoE measurement performed in a radio resource control (RRC) idle state or an RRC inactive state in an access stratum (AS) layer memory of the UE, and
transmit, to the base station, a QoE report including the result of the QoE measurement based on the configuration information.

12. The UE of claim 11, wherein the AS layer memory is shared with a memory for a QoE paused measurement report or is additional to the memory for the QoE paused measurement report.

13. The UE of claim 11, wherein, in case that the AS layer memory is full, at least one QoE report is discarded based on a storage order or a priority.

14. The UE of claim 11, wherein the QoE report is transmitted to the base station in an RRC connected state.

15. The UE of claim 11, wherein the QoE report is for multicast and broadcast services (MBS) broadcast.

16. A base station in a wireless communication system, the base station comprising:
a transceiver; and
at least one processor coupled with the transceiver and configured to:
transmit, to a user equipment (UE), configuration information for a quality of experience (QoE) measurement, and
receive, from the UE, a QoE report including a result of the QoE measurement based on the configuration information,
wherein the result of the QoE measurement performed in a radio resource control (RRC) idle state or an RRC inactive state is stored in an access stratum (AS) layer memory of the UE.

17. The base station of claim 16, wherein the AS layer memory is shared with a memory for a QoE paused measurement report or is additional to the memory for the QoE paused measurement report.

18. The base station of claim 16, wherein, in case that the AS layer memory is full, at least one QoE report is discarded based on a storage order or a priority.

19. The base station of claim 16, wherein the QoE report is received from the UE in an RRC connected state.

20. The base station of claim 16, wherein the QoE report is for multicast and broadcast services (MBS) broadcast.
